(19) United States
(12) Patent Application Publication
(10) Pub. No.: US 2021/0046960 A1
(43) Pub. Date: Feb. 18, 2021

(54) SYSTEMS AND METHODS FOR WORKER SAFETY

(71) Applicant: Humatics Corporation, Waltham, MA (US)

(72) Inventors: Aaron Whittemore, Millville, MA (US); Joshua Senna, Brookline, MA (US); James Campbell Kinsey, Brookline, MA (US)

(21) Appl. No.: 16/992,929

(22) Filed: Aug. 13, 2020

Related U.S. Application Data
(60) Provisional application No. 62/885,973, filed on Aug. 13, 2019.

(51) Int. Cl. B61L 23/06; G08B 21/02; H04B 1/69; G01S 13/76; B61L 25/02; B61L 15/00

(52) U.S. Cl. CPC B61L 23/06; G08B 21/02; B61L 15/0027; G01S 13/76; B61L 25/025; H04B 1/69

(57) ABSTRACT

A system, comprising: a plurality of wayside devices positioned along a train track, the plurality of wayside devices having known positions, each of the plurality of wayside devices comprising at least one first radio-frequency (RF) antenna; a work zone device positioned along the train track, the work zone device comprising at least one second RF antenna configured to transmit RF signals to and/or receive RF signals from the plurality of wayside devices; and at least one processor configured to determine a position of the work zone device using the known positions and using RF signals transmitted between the work zone device and the plurality of wayside devices.

### CROSS REFERENCE TO RELATED APPLICATIONS

This Application claims priority under 35 U.S.C. § 119(e) to U.S. Provisional Application Ser. No. 62/885,973, filed Aug. 13, 2019, under Attorney Docket No.: H0908.70081US00, and titled “ULTRA-WIDEBAND WORKER SAFETY PROTECTION SYSTEMS AND METHODS,” which is incorporated by reference in its entirety herein.

### BACKGROUND

Train systems, such as urban subway systems, typically undergo periodic maintenance and construction, during which time workers may be actively working in one or more work zones within the train system. Since an active work zone may include parts of one or more train tracks, trains are conventionally prevented from traveling or forced to slow their travel along the train track(s) in or near the active work zone while work is ongoing to ensure safe working conditions for workers in the work zone. However, as a result, train service may be unavailable or delayed in parts of the train system connected by the impacted areas of the train tracks during the periods of maintenance or construction.

### SUMMARY

Some aspects of the present disclosure provide a work zone device positioned along a train track, the work zone device configured to communicate with a first portable device associated with a first worker in a work zone along the train track. The work zone device comprises at least one first radio-frequency (RF) antenna configured to transmit RF signals to and receive RF signals from a carborne device on a train traveling along the train track and at least one first processor configured to determine a distance between the work zone device and the carborne device at least in part by transmitting at least one RF signal to and receiving at least one RF signal from the carborne device, determine, based on the determined distance, whether to transmit an alert notification to the first portable device, and transmit the alert notification to the first portable device when it is determined to transmit the alert notification to the first portable device.

In some embodiments, the RF signals are ultra-wideband (UWB) signals.

In some embodiments, the at least one first RF antenna is configured to transmit and receive RF signals having a bandwidth of at least 500 megahertz (MHz).

In some embodiments, the at least one first RF antenna is configured to transmit and receive RF signals having a bandwidth of at least 2 gigahertz (GHz).

In some embodiments, the at least one first RF antenna is configured to transmit and receive RF signals in a range within 3-10 GHz.

In some embodiments, the at least one first RF antenna is configured to transmit and receive RF signals in a 3-5 GHz frequency range.

In some embodiments, the at least one first RF antenna is configured to transmit and receive RF signals in a 6-9 GHz frequency range.

In some embodiments, the at least one first RF antenna is configured to receive a first RF signal from the carborne device, and the at least one first processor is configured to determine, based on receiving the first RF signal, that the distance between the work zone device and the carborne device is within a predetermined threshold distance.

In some embodiments, the at least one first RF antenna is further configured to transmit a second RF signal to the carborne device in response to receiving the first RF signal.

In some embodiments, a system comprises the work zone device and the carborne device, the carborne device comprising at least one second RF antenna configured to transmit the first RF signal and receive the second RF signal and at least one second processor configured to determine the distance between the work zone device and the carborne device using a time of arrival of the second RF signal.

In some embodiments, the at least one second processor of the carborne device is further configured to alert an operator of the train responsive to determining that the distance between the work zone device and the carborne device is within a predetermined threshold distance.

In some embodiments, the at least one first RF antenna is configured to transmit a first RF signal to the carborne device and receive a second RF signal from the carborne device, and the at least one first processor is configured to determine the distance between the first device and the second device using a time of arrival of the second RF signal.

In some embodiments, the work zone device is configured to transmit the alert to the first portable device via an intermediate device.

In some embodiments, a system comprises the work zone device and the first portable device, the first portable device comprising at least one second RF antenna configured to receive the alert notification from the work zone device and at least one second processor configured to cause the first portable device to alert the first worker responsive to receiving the alert notification from the work zone device.

In some embodiments, the at least one second processor of the first portable device is configured to cause the first portable device to generate an alert selected from the group consisting of an audio alert, a haptic alert, and a visual alert for the first worker responsive to receiving the alert notification from the work zone device.

In some embodiments, the at least one second processor of the first portable device is configured to receive an input from the first worker confirming that the alert was received and transmit a signal indicating that the alert has been confirmed to the work zone device.

Some aspects of the present disclosure provide a method performed by a work zone device positioned along a train track, the method comprising determining a distance between the work zone device and a carborne device, at least in part, by transmitting at least one radio-frequency (RF) signal to and/or receiving at least one RF signal from the carborne device, determining, based on the determined distance, whether to transmit an alert notification to a first portable device, the first portable device being associated with a first worker in a work zone along the train track, and transmitting the alert notification to the first portable device when it is determined to transmit the alert notification to the first portable device.

In some embodiments, the RF signals are ultra-wideband (UWB) signals.

In some embodiments, the RF signals have a bandwidth of at least 500 megahertz (MHz).

In some embodiments, the RF signals have a bandwidth of at least 2 gigahertz (GHz).

In some embodiments, the RF signals are in a range within 3-10 GHz.

In some embodiments, the RF signals are in a 3-5 GHz frequency range.

In some embodiments, the RF signals are in a 6-9 GHz frequency range.

In some embodiments, the method further comprises receiving a first RF signal from the carborne device and determining, based on receiving the first RF signal, that the distance between the work zone device and the carborne device is within a predetermined threshold distance.

In some embodiments, the method further comprises transmitting a second RF signal to the carborne device in response to receiving the first RF signal.

In some embodiments, the method further comprises transmitting the first RF signal from the carborne device to the work zone device, receiving the second RF signal at the carborne device, and determining the distance between the work zone device and the carborne device using a time of arrival of the second RF signal.

In some embodiments, the method further comprises alerting an operator of the train responsive to determining that the distance between the work zone device and the carborne device is within a predetermined threshold distance.

In some embodiments, the method further comprises transmitting a first RF signal to the carborne device, receiving a second RF signal from the carborne device, and determining the distance between the first device and the second device using a time of arrival of the second RF signal.

In some embodiments, the alert is transmitted to the first portable device via an intermediate device.

In some embodiments, the method further comprises receiving the alert notification from the work zone device at the first portable device and alerting the first worker responsive to receiving the alert notification from the work zone device.

In some embodiments, alerting the first worker comprises generating an alert selected from the group consisting of an audio alert, a haptic alert, and a visual alert.

In some embodiments, the method further comprises receiving an input from the first worker confirming that the alert was received and transmitting a signal indicating that the alert has been confirmed to the work zone device.

Some aspects of the present disclosure provide a system comprising a plurality of wayside devices positioned along a train track, the plurality of wayside devices having known positions, each of the plurality of wayside devices comprising at least one first radio-frequency (RF) antenna, a work zone device positioned along the train track, the work zone device comprising at least one second RF antenna configured to transmit RF signals to and/or receive RF signals from the plurality of wayside devices, and at least one processor configured to determine a position of the work zone device using the known positions and using RF signals transmitted between the work zone device and the plurality of wayside devices.

In some embodiments, the at least one first RF antenna and the at least one second RF antenna are configured to transmit and receive ultra-wideband (UWB) signals.

In some embodiments, at least one first RF antenna and the at least one second RF antenna are configured to transmit and receive RF signals having a bandwidth of at least 500 megahertz (MHz).

In some embodiments, the at least one first RF antenna and the at least one second RF antenna are configured to transmit and receive RF signals having a bandwidth of at least 2 gigahertz (GHz).

In some embodiments, the at least one first RF antenna and the at least one second RF antenna are configured to transmit and receive RF signals in a range within 3-10 GHz.

In some embodiments, the at least one RF antenna and the at least one second RF antenna are configured to transmit and receive RF signals in a 3-5 GHz frequency range.

In some embodiments, the at least one RF antenna and the at least one second RF antenna are configured to transmit and receive RF signals in a 6-9 GHz frequency range.

In some embodiments, the at least one processor is configured to determine the position of the work zone device with a precision of less than 50 centimeters (cm).

In some embodiments, the at least one processor is configured to determine the position of the work zone device with a precision of less than 10 cm.

In some embodiments, the at least one second RF antenna of the work zone device is configured to transmit a first RF signal to the plurality of wayside devices and receive a second RF signal from the plurality of wayside devices, and the work zone device comprises a first processor of the at least one processor, the first processor configured to determine the position of the work zone device using a time of arrival of the second RF signal and at least one of the known positions.

In some embodiments, the at least one second RF antenna of the work zone device is configured to receive at least one first RF signal from the plurality of wayside devices, and

the work zone device comprises a first processor of the at least one processor, the first processor configured to determine relative position information of the work zone device using a time of arrival of the at least one first RF signal and at least one of the known positions and provide the relative position information to a second processor of the at least one processor over a network, and the second processor is configured to determine the position of the work zone device using the relative position information.

In some embodiments, the system further comprises a network device comprising the second processor, the second processor being further configured to provide the position of the work zone device to a remote device over the network.

In some embodiments, the system further comprises the remote device, and the remote device is configured to display the position of the work zone device relative to a position of a train traveling along the train track.

In some embodiments, the remote device is a carborne device on the train.

In some embodiments, a first wayside device of the plurality of wayside devices comprises a first RF antenna of the at least one first RF antenna, a first processor of the at least one processor, and has a first known position of the known positions, the first RF antenna of the first wayside device is configured to transmit a first RF signal to the work zone device and receive a second RF signal from the work zone device, and the first processor is configured to determine the position of the work zone device using a time of arrival of the second RF signal and the first known.

In some embodiments, the work zone device is associated with a work zone and is further configured to communicate an alert notification to a first portable device associated with a first worker in the work zone.

In some embodiments, the at least one second RF antenna of the work zone device is further configured to transmit the alert notification to the first portable device.

In some embodiments, the system further comprises the first portable device, the first portable device comprising at least one third RF antenna configured to receive the alert notification from the work zone device and at least one third processor configured to cause the first portable device to alert the first worker responsive to receiving the alert notification from the work zone device.

In some embodiments, the at least one third processor of the first portable device is configured to cause the first portable device to generate an alert selected from the group consisting of an audio alert, a haptic alert, and a visual alert for the first worker responsive to receiving the alert notification from the work zone device.

In some embodiments, the at least one third processor is further configured to receive an input from the first worker confirming that the alert was received and transmit a signal indicating that the alert has been confirmed to the work zone device.

In some embodiments, the at least one second antenna of the work zone device is configured to transmit RF signals to and/or receive RF signals from the first portable device and the at least one processor is configured to determine a position of the first portable device using the RF signals transmitted between the work zone device and the first portable device.

In some embodiments, the at least one second antenna of the work zone device is configured to transmit a first RF signal to the first portable device and receive a second RF signal from the first portable device, and the at least one processor is configured to determine the position of the first portable device using a time of arrival of the second RF signal.

Some aspects of the present disclosure provide a method performed by a plurality of devices positioned along a train track and at least one processor, the plurality of devices comprising a plurality of wayside devices having known positions and a work zone device. The method comprises transmitting radio-frequency (RF) signals between the plurality of wayside devices and the work zone device and determining, by the at least one processor, a position of the work zone device using the known positions and the RF signals.

In some embodiments, the RF signals are ultra-wideband (UWB) signals.

In some embodiments, the RF signals have a bandwidth of at least 500 megahertz (MHz).

In some embodiments, the RF signals have a bandwidth of at least 2 gigahertz (GHz).

In some embodiments, the RF signals are in a range within 3-10 GHz.

In some embodiments, the RF signals are in a 3-5 GHz frequency range.

In some embodiments, the RF signals are in a 6-9 GHz frequency range.

In some embodiments, the position of the work zone device is determined with a precision of less than 50 centimeters (cm).

In some embodiments, the position of the work zone device is determined with a precision of less than 10 cm.

In some embodiments, the method further comprises transmitting a first RF signal to the plurality of wayside devices, receiving a second RF signal from the plurality of wayside devices, and determining, by a first processor of the at least one processor, the position of the work zone device using a time of arrival of the second RF signal and at least one of the known positions, the work zone device comprising the first processor.

In some embodiments, the method further comprises receiving at least one first RF signal from the plurality of wayside devices, determining, by a first processor of the at least one processor, relative position information of the work zone device using a time of arrival of the at least one first RF signal, the work zone device comprising the first processor, and providing the relative position information to a second processor of the at least one processor over a network, the second processor being configured to determine the position of the work zone device using the relative position information.

In some embodiments, the method further comprises providing, by the second processor, the position of the work zone device to a remote device over the network.

In some embodiments, the method further comprises displaying, by the remote device, the position of the work zone device relative to a position of a train traveling along the train track.

In some embodiments, the remote device is a carborne device on the train.

In some embodiments, the method further comprises transmitting a first RF signal from a first wayside device of the plurality of wayside devices to the work zone device, the first wayside device having a first known position of the known positions, receiving a second RF signal from the work zone device at the first wayside device, and determining, by a first processor of the at least one processor, the position of the work zone device using a time of arrival of the second RF signal and the first known position, the first wayside device comprising the first processor.

In some embodiments, the work zone device is associated with a work zone and the method further comprises transmitting an alert notification from the work zone device to a first portable device associated with a first worker in the work zone.

In some embodiments, the method further comprises receiving the alert notification from the work zone device at the first portable device and alerting the first worker responsive to receiving the alert notification from the work zone device.

In some embodiments, alerting the first worker comprises generating an alert selected from the group consisting of an audio alert, a haptic alert, and a visual alert.

In some embodiments, the method further comprises receiving an input from the first worker confirming that the alert was received and transmitting a signal indicating that the alert has been confirmed to the work zone device.

In some embodiments, the method further comprises transmitting RF signals to and/or receiving RF signals from the first portable device and determining a position of the first portable device using at least one RF signal transmitted to and/or received from the first portable device.

In some embodiments, the method further comprises transmitting a first RF signal to the first portable device and receiving a second RF signal from the first portable device and determining the position of the first portable device using a time of arrival of the second RF signal.

Some aspects of the present disclosure provide a system comprising a work zone device positioned along a train track, the work zone device comprising at least one first radio-frequency (RF) antenna configured to transmit RF signals to and receive RF signals from a carborne device on a train traveling along the train track and at least one first processor configured to determine a distance between the work zone device and the carborne device at least in part by transmitting at least one RF signal to and receiving at least one RF signal from the carborne device, determine, based on the determined distance, whether to transmit an alert notification, and transmit the alert notification when it is determined to transmit the alert notification, and a first portable device associated with a first worker in a work zone along the train track, the first portable device comprising at least one second RF antenna configured to receive the alert notification from the work zone device and at least one second processor configured alert the first worker in response to receiving the alert notification.

In some embodiments, the at least one first RF antenna is configured to receive a first RF signal from the carborne device and the at least one first processor is configured to determine, based on receiving the first RF signal, that the distance between the work zone device and the carborne device is within a predetermined threshold distance.

In some embodiments, the at least one first RF antenna is configured to transmit a first RF signal to the carborne device and receive a second RF signal from the carborne device and the at least one first processor is configured to determine the distance using a time of arrival of the second RF signal.

In some embodiments, the at least one first RF antenna is configured to transmit and receive ultra-wideband (UWB) signals having a bandwidth of at least 500 MHz.

In some embodiments, the at least one second processor of the first portable device is configured to generate an alert selected from the group consisting of an audio alert, a haptic alert, and a visual alert for the first worker responsive to receiving the alert notification from the work zone device.

In some embodiments, the at least one second processor of the first portable device is configured to receive an input from the first worker confirming that the alert was received and transmit a signal indicating that the alert has been confirmed to the work zone device.

Some aspects of the present disclosure provide a work zone device positioned along a train track, the work zone device comprising at least one first radio-frequency (RF) antenna configured to transmit RF signals to and/or receive RF signals from a plurality of wayside devices having known positions and at least one first processor configured to determine a position of the work zone device using the known positions and using RF signals transmitted between the work zone device and the plurality of wayside devices.

In some embodiments, the at least one first RF antenna is configured to transmit and/or receive ultra-wideband (UWB) signals having a bandwidth of at least 500 MHz.

In some embodiments, the at least one first RF antenna is configured to transmit and/or receive RF signals in a 3-10 GHz frequency range.

In some embodiments, the at least one first RF antenna of the work zone device is configured to receive a first plurality of RF signals from the first plurality of wayside devices and the at least one first processor is configured to determine relative position information of the work zone device using arrival times of the first plurality of RF signals.

In some embodiments, the at least one first RF antenna is further configured to transmit a second plurality of RF signals to the plurality of wayside devices and is configured to receive the first plurality of RF signals from the plurality of wayside devices in response to the second plurality of RF signals.

In some embodiments, the at least one first processor is configured to determine the position of the work zone device using the relative position information and at least one of the known positions of the plurality of wayside devices.

In some embodiments, the at least one first processor is configured to provide the relative position information to a network device over a network, the network device being configured to determine the position of the work zone device using the relative position information and the known positions of the wayside devices stored by the network device.

### BRIEF DESCRIPTION OF DRAWINGS

Various aspects and embodiments of the disclosed technology will be described with reference to the following figures. It should be appreciated that the figures are not necessarily drawn to scale.

FIG. 1 is a drawing of an illustrative radio-frequency (RF) worker safety system comprising a plurality of work zone devices positioned along a train track, a carborne device on a train traveling along the train track, and a portable device, in accordance with some embodiments of the technology described herein;

FIG. 2 is a drawing of another illustrative RF worker safety system comprising a plurality of work zone devices and a plurality of wayside devices positioned along a train track, a carborne device on a train traveling along the train track, and a portable device, in accordance with some embodiments of the technology described herein;

FIG. 3 is a drawing of another illustrative RF worker safety system that includes a plurality of work zone devices and a plurality of wayside devices positioned along a train track, a carborne device on a train traveling along the train track, a portable device, and a network device, in accordance with some embodiments of the technology described herein;

FIG. 4 is a drawing of another illustrative RF worker safety system that includes a work zone device and a plurality of wayside devices positioned along a train track, with RF signals transmitted between the work zone device and the plurality of wayside devices, in accordance with some embodiments of the technology described herein;

FIG. 5 is a drawing of another illustrative RF worker safety system that includes a work zone device and a plurality of wayside devices positioned along a train track, with RF signals transmitted from the work zone device to the plurality of wayside devices, in accordance with some embodiments of the technology described herein;

FIG. 6 is a drawing of an illustrative RF worker safety system that includes a portable device and a carborne device on a train traveling along a train track, with RF signals transmitted between the portable device and the carborne device, in accordance with some embodiments of the technology described herein;

FIG. 7 is a drawing of an illustrative work zone device that may be included in an RF worker safety system, in accordance with some embodiments of the technology described herein;

FIG. 8 is a drawing of an illustrative carborne device that may be included in an RF worker safety system, in accordance with some embodiments of the technology described herein;

FIG. 9 is a drawing of an illustrative portable device that may be included in an RF worker safety system, in accordance with some embodiments of the technology described herein;

FIG. 10 is a drawing of an illustrative wayside device that may be included in an RF worker safety system, in accordance with some embodiments of the technology described herein;

FIG. 11 is a drawing of an illustrative RF sub-system that may be included in an RF worker safety system, in accordance with some embodiments of the technology described herein;

FIG. 12 is a drawing of an illustrative method that may be performed by one or more components of an RF worker safety system, in accordance with some embodiments of the technology described herein;

FIG. 13 is a drawing of an illustrative method that may be performed by components of an RF worker safety system, in accordance with some embodiments of the technology described herein;

FIG. 14 is a drawing of an illustrative computer system that may be included in an RF worker safety system, in accordance with some embodiments of the technology described herein;

FIG. 15 is a drawing of a non-volatile storage device that may be included an RF worker safety subsystem, in accordance with some embodiments of the technology described herein.

### DETAILED DESCRIPTION

The inventors have developed improved worker safety systems and methods that enhance worker safety conditions in vehicular environments such as on or proximate train tracks. In some embodiments, systems described herein include devices configured to transmit radio-frequency (RF) signals (e.g., ultra-wideband (UWB) RF signals) to other devices in the system and/or receive RF signals from the other devices in the system, such that distances between the devices and/or the positions of the devices may be determined with enhanced precision. In this manner, devices described herein make operation of vehicles within and/or in proximity to active work zones safer by more precisely determining the distance between a vehicle and a work zone and/or the positions of the work zone, vehicles, and/or workers in the work zone. This allows train operators, workers in a work zone along train tracks, and/or any other personnel to have improved situational awareness and make the work zone environment safer for all those involved.

The inventors have recognized that conventional worker safety systems are expensive to implement, and even when implemented, they are not sufficiently reliable and do not provide train personnel with sufficient information to confidently perform their duties. For instance, some conventional systems may determine the position of a train near a work zone using global positioning system (GPS) technology. GPS-based systems require the use of satellites that may lose signal connection to devices in a tunnel, making such systems impractical to implement in systems that include tunnels (e.g., subway systems). However, GPS-based systems also provide very limited precision. Other systems may determine the position of a train near a work zone using optical technology such as lasers. However, optical-based systems are also expensive to implement, especially when high precision is required, and usually require devices to be within a line of sight of one another in order to communicate.

To address these drawbacks of conventional worker safety systems, the inventors developed techniques for determining positions of and/or distances between devices in a worker safety system using RF-based (e.g., UWB) technology capable of determining the positions and/or distances with a high degree of precision (e.g., within 10 centimeters in some embodiments), without requiring a line of sight between the devices, and at lower cost than conventional GPS- or laser-based systems. In some embodiments, distances and/or positions with a high degree of precision may be obtained through the use of UWB RF signals having high signal bandwidth (e.g., at least 500 MHz). For example, a device that receives a UWB RF signal with high signal bandwidth may be able to determine precise timing information by processing the received signal. In some embodiments, worker safety systems described herein may be inexpensive to deploy temporarily in a train system with little or no existing RF-based infrastructure. For example, the worker safety system may include one or more work zone devices positioned (e.g., temporarily) along a train track and configured to transmit RF signals to and/or receive RF signals from a carborne device on a train traveling along the train track. In this example, the work zone device(s) may be further configured to communicate alert notifications to one or more portable devices (e.g., used by workers in the work zone) indicating a distance between the work zone device and the carborne device on the train.

In some embodiments, work zone devices may be deployed (e.g., temporarily) in a system that includes existing wayside device infrastructure, such as one or more wayside devices positioned along a train track and having known positions. For example, wayside devices and work zone devices may be configured to determine the positions (e.g., temporary positions) of the work zone devices using the known location of the wayside devices. In some embodiments, work zone devices, wayside devices, carborne devices, and/or portable devices in the system may be interconnected by a communication network and/or may be connected to a network device (e.g., storing the known positions of the wayside devices). For example, the network device may be configured to determine positions of devices in the system using distance data determined by the devices, storing positions of multiple devices, and/or providing device positions to devices in the system for displaying to train personnel. As a result, the techniques described herein improve upon conventional worker safety systems by using RF-based technology to obtain precise situational awareness of people, devices, and/or trains at or near a work zone.

In some embodiments, a worker safety system according to techniques described herein may include a work zone device positioned along a train track and including at least one RF antenna configured to transmit RF signals to and/or receive RF signals from a carborne device on a train traveling along the train track. For example, the work zone device may be associated with a work zone. For example, the RF signals may be UWB signals, such as RF signals having a bandwidth of at least 500 MHz, at least 1 GHz, or at least 2 GHz (e.g., in a 3-5 GHz or 6-9 GHz frequency range). In some embodiments, the RF signals may be RF signals in any suitable frequency range (e.g., 3-10 GHz, 3-5 GHz, 6-9 GHz, 2-8 GHz, 5-10 GHz, or any other suitable frequency range within these ranges). In some embodiments, at least one processor of the work zone device may be configured to determine a distance between the work zone device and the carborne device using the RF signals transmitted between the work zone device and the carborne device. For example, the work zone device may be configured to determine the distance using a time of arrival of an RF signal received from the carborne device.

In some embodiments, the work zone device may be further configured to determine, based on the determined distance, whether to transmit an alert notification to a first portable device associated with a worker in the work zone. For example, the work zone device may be configured to determine whether the carborne device is within a predetermined threshold distance of the work zone device, and transmit the alert notification if so. In some embodiments, the work zone device may be configured to transmit the alert notification to the portable device using one or more RF (e.g., UWB) signals. For example, the portable device may be configured to provide an audio, visual, and/or haptic alert to the worker in response to receiving the alert notification. In some embodiments, the portable device may be configured to prompt the worker for input to confirm that the alert notification was received and transmit a signal to the work zone device indicating that the alert has been confirmed.

In some embodiments, the carborne device may be configured to alert an operator of the train and/or to instruct a control system of the train to decrease speed and/or stop in response to receiving an RF signal from the work zone device. For example, the carborne device may be configured to cause an audio, visual, and/or haptic device onboard the train to alert the operator in response to determining that the work zone device is within the predetermined threshold distance of the carborne device.

In some embodiments, a worker safety system according to techniques described herein may include a plurality of devices positioned along a train track, the plurality of devices including a plurality of wayside devices having known positions and a work zone device. For example, positions of the wayside devices may be stored in the memory of a device in the system, and the work zone device may be associated with a work zone. In this example, the position of the wayside device may not be stored in memory in the system. In some embodiments, the wayside devices may include at least one first RF antenna and the work zone device may include at least one second RF antenna configured to transmit RF signals to and/or receive RF signals from the wayside devices. For example, the wayside device may be configured to transmit first RF signals to the wayside devices and receive second RF signals from the wayside devices in response, or vice versa. The system may further include at least one processor configured to determine a position of the work zone device using the known positions of the wayside devices and the RF signals transmitted between the work zone device and the wayside devices. For example, the processor(s) may be included in the work zone device, the wayside devices, and/or a network device configured to receive information from the work zone device and/or the wayside devices over a network.

In some embodiments, the work zone device and/or the wayside devices may be configured to determine the position of the work zone device, at least in part, using arrival times of RF signals transmitted from the work zone device to the wayside devices and/or vice versa. For example, the work zone device and/or the wayside device may be configured to determine relative position information of the work zone device (e.g., with respect to the wayside devices), and determine the position of the work zone device using the relative position information and the known positions of the wayside devices, or provide the relative position of the work zone device to a network device for determination of the position of the work zone device using the known positions of the wayside devices.

In some embodiments, the position of the work zone device may be provided to one or more remote devices over a network, such as for displaying with reference to positions of carborne devices on trains and/or portable devices in the system.

It should be appreciated that the techniques introduced above and described in greater detail below may be implemented in any of numerous ways, as the techniques are not limited to any particular manner of implementation. Examples of details of implementation are provided herein solely for illustrative purposes. Furthermore, the techniques disclosed herein may be used individually or in any suitable combination, as aspects of the technology described herein are not limited to the use of any particular technique or combination of techniques.

In some embodiments, a work zone may be an area including or near a portion of train tracks in which one or more workers are performing various tasks (e.g., construction, maintenance, monitoring, surveying, etc.) and/or in which equipment is being used to perform any such task(s).

In some embodiments, one or more work zone devices may be associated with a work zone. For example, in some embodiments, one or more work zone devices may be positioned in or near a work zone. As another example, in some embodiments, the work zone device(s) may at least partially demarcate boundaries of the work zone. For example, a work zone device may be positioned in a warning zone near the work zone and configured to communicate with a carborne device on a train traveling towards the work zone when the carborne device enters the warning zone. In this example, the warning zone may extend from a work zone device toward the carborne device and may extend as far as the work zone device's signal range permits. Alternatively or additionally, the warning zone may extend up to a predetermined threshold distance from the work zone device. For example, the predetermined threshold distance may be based on an estimated distance over which the train is capable of reducing speed and/or stopping in response to communicating with the work zone device.

In some embodiments, a carborne device may be any device onboard a train (e.g., mounted in or on a train car) or other vehicle. For example, the carborne device may be onboard a passenger car, an engine car, a cargo car, and/or any other suitable train car and/or part of a train. In some embodiments, the carborne device may be coupled to (e.g., communicatively coupled, electrically coupled, and/or mechanically coupled) one or more other devices onboard the train, such as a train control system and/or train alert system.

In some embodiments, a portable device may be a device worn, carried by, and/or otherwise kept near a worker (or multiple workers) while the worker is (or workers are) in a work zone. For example, a portable device may be the worker's personal smartphone device or a smartphone device leased to the worker. In another example, the portable device may be a wearable device configured to be worn on the worker's wrist (e.g., a smart watch) or elsewhere on the worker's person (e.g., construction vest). As a further alternative, the portable device may be part of or configured for attaching to a piece of equipment used by the worker in the work zone.

In some embodiments, a wayside device may be a device positioned along a vehicle way, such as a train track, and having a known position. For example, wayside devices may be permanently installed along a train track with a predetermined spacing between the wayside devices. In some embodiments, wayside devices may be positioned along a single side of a train track, along both sides of a train track, along a single side of each of multiple train tracks, and/or along both sides of each of multiple train tracks.

In some embodiments, the known positions of the wayside devices may be stored in memory in any suitable format and/or coordinate system. In some embodiments, the known positions may be one dimensional (e.g., along a train track), two dimensional (e.g., parallel and perpendicular to the train track), and/or three dimensional (e.g., parallel and perpendicular to the train track and also in a height direction). In some embodiments, the positions of the wayside devices may be determined by surveying (e.g., during installation), and the positions may be stored in memory in one or more devices in the worker safety system. For example, in some embodiments, the known positions for multiple wayside devices may be determined and/or specified with respect to a common reference frame. In this example, the known positions may be used to determine the positions of one or more other devices (e.g., work zone devices, carborne devices, and/or portable devices) with respect to the common reference frame, such as using relative distance information determined using RF signals transmitted between two or more devices. In some embodiments, an operations and/or control center and/or a device on a train may be configured to display the positions of the various devices with respect to the reference frame, thus enhancing situational awareness—where the devices are precisely positioned relative to other devices, to provide visualizations of the positions, and the like.

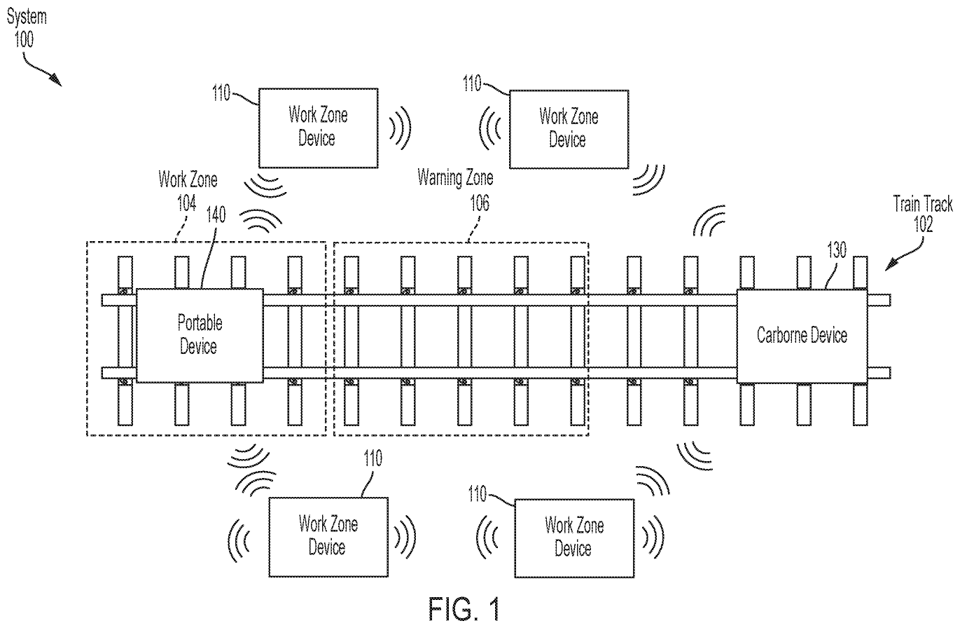

Turning to the figures, FIG. 1 is a drawing of an illustrative radio-frequency (RF) worker safety system 100 that includes a plurality of work zone devices 110 positioned along a train track 102, a carborne device 130 on a train traveling along the train track 102, and a portable device 140, in accordance with some embodiments of the technology described herein. As shown in FIG. 1, the portable device 140 is positioned in a work zone 104 and the work zone devices 110 are positioned near (e.g., at ends of) a warning zone 106 positioned next to the work zone 104. In some embodiments, the work zone devices 110 may be positioned near the work zone 104, such as within a threshold distance of the work zone 104. For example, the work zone devices 110 may be associated with the work zone 104. In this example, the work zone devices 110 may be portable and/or deployable devices positioned along the train track to demarcate the work zone 104. The warning zone 106 may extend a predetermined threshold distance from the work zone device 110, such as the signal range of the work zone device 110 and/or an estimated distance over which the train is capable of reducing its speed and/or stopping. In some embodiments, the portable device 140 may be associated with a worker working in the work zone 104. For example, the portable device 140 may be configured to be worn and/or carried by the worker.

In some embodiments, at least one of the work zone devices 110 may be configured to transmit RF signals to and receive RF signals from the carborne device 130. For example, in FIG. 1, one of the work zone devices 110 positioned at the edge of the warning zone 106 closest to the carborne device 130 may be configured to receive a first RF signal from the carborne device 130 and transmit a second RF signal to the carborne device 130 in response. Alternatively, the work zone device 110 may be configured to transmit the first RF signal to the carborne device 130 and receive a second RF signal from the carborne device 130 in response to transmitting the first RF signal. In some embodiments, the first and second RF signals may be UWB signals. For example, according to various embodiments, the first and second RF signals may have a bandwidth of at least 500 MHz, at least 1 GHz, at least 2 GHz, such as having a bandwidth between 3 GHz and 5 GHz.

In some embodiments, at least one of the work zone devices 110 may be configured to determine a distance between the work zone device 110 and the carborne device 130 using the RF signals transmitted between the work zone device 110 and the carborne device 130. In some embodiments, the work zone device 110 may be configured to determine the distance between the work zone device 110 and the carborne device 130, at least in part, by determining that the carborne device 130 is within a predetermined threshold distance of the work zone device 110. For example, a work zone device 110 positioned at or near (e.g., at the edge of) the warning zone 106 may be configured to determine that the carborne device 130 is within a predetermined threshold distance of the work zone device 110, based, at least in part, on receiving a first RF signal from the carborne device 130. In this example, determining the distance using the RF signals includes using the arrival of at least one RF signal.

In some embodiments, the work zone device 110 may be configured to determine the distance between the work zone device and the carborne device 130, at least in part, by transmitting a first RF signal to the carborne device 130 and receiving a second RF signal from the carborne device 130. For example, the work zone device 110 may be configured to determine the distance using a time of arrival of the second RF signal at the work zone device 110, such as by comparing the time of arrival of the second RF signal to a time of transmission of the first RF signal. In this example, using the RF signals includes using the time of arrival of the second RF signal, which may indicate a time of flight of the second RF signal or the first and second RF signals (e.g., a distance may be determined by dividing the time of flight by the wave speed). Alternatively or additionally, in some embodiments, using the RF signals may include using information obtained via processing the RF signal(s), such as by demodulating the RF signal(s). In some embodiments, the work zone device 110 may be configured to determine the distance between the work zone device 110 and the carborne device 130 with a precision of less than 50 centimeters (cm), such as less than 20 cm, less than 10 cm, or less than 5 cm.

In some embodiments, at least one of the work zone devices 110 may be configured to determine, based on the distance between the work zone device 110 and the carborne device 130, whether to transmit an alert notification to the portable device 140. For example, the work zone device 110 may be configured to transmit the alert notification responsive to receiving a first RF signal from the carborne device 130 indicating that the carborne device 130 is within a predetermined threshold distance of the work zone device 110. In another example, the work zone device 110 may be configured to determine the distance using a first RF signal transmitted to the carborne device 130 and a second RF signal received from the carborne device 130, such as by determining that the determined distance is within a predetermined threshold distance. In some embodiments, the work zone device 110 may include a light, such as a strobe light, and may be configured to turn on and/or flash the strobe light in response to determining that the carborne device 130 is within the predetermined threshold distance of the work zone device 110. In some embodiments, the predetermined threshold distance may be the distance from which the warning zone 106 extends from the work zone device 110, such that determining that the carborne device 130 is within the predetermined threshold distance indicates that the train is near or has entered the warning zone 106.

In some embodiments, at least one of the work zone devices 110 may be configured to transmit the alert notification to the portable device 140 when it is determined to transmit the alert notification to the portable device 140. In some embodiments, the work zone device 110 configured to determine the distance between the work zone device 110 and the carborne device 130 and/or whether to transmit the alert notification may be further configured to transmit the alert notification to the portable device 140. Alternatively or additionally, in some embodiments, the work zone device 110 may be configured to transmit the alert notification to the portable device 140 via one or more intermediate devices. For example, a first work zone device 110 (e.g., the work zone device 110 positioned at an end of the warning zone 106 closest to the work zone 104) may be configured to transmit the alert notification to the portable device 140 in response to a second work zone device 110 (e.g., at the end of the warning zone 106 closest to the carborne device 130) determining the distance between the second work zone device 110 and the carborne device 130. In this example, the second work zone device 110 may be configured to communicate an indication of the determination result to the first work zone device 110. In some embodiments, the work zone device 110 may be configured to transmit the alert notification to the portable device 140 using one or more RF signals. In some embodiments, the alert notification may include any suitable data in any suitable format. In some embodiments, the alert notification may be transmitted using any suitable communication protocol.

In some embodiments, the portable device 140 may be configured to alert the worker with whom the portable device 140 is associated in response to receiving the alert notification from the work zone device 110. For example, the portable device 140 may be configured to provide an audio, visual, and/or haptic (e.g., vibration) alert to the worker via one or more audio, display, and/or haptic components of the portable device 140. In some embodiments, the portable device 140 may prompt the worker for input to confirm receiving the alert notification. For example, the portable device 140 may be configured to receive input from the worker via a button displayed on touch screen of the portable device and/or a physical button on an exterior surface of the portable device 140. In some embodiments, the portable device 140 may be configured to communicate to one or more of the work zone devices 110 that the worker has confirmed the alert, such as using one or more RF signals.

In some embodiments, the carborne device 130 may be configured to alert an operator of the train and/or a train control system onboard the train of the work zone based on the RF signals transmitted between the work zone device 110 and the carborne device 130. For example, the carborne device 130 may be configured to alert the operator by causing one or more audio, display, and/or haptic devices onboard the train to provide an audio, visual, and/or haptic alert to the operator, and/or by prompting the operator for input to confirm that the alert was received. In some embodiments, the carborne device 130 may be configured to alert the operator at a threshold time (e.g., 15 seconds) before the train is estimated to reach the work zone. For example, the time may be determined using the determined distance between the carborne device 130 and the work zone device 110 and the speed of the train. Alternatively or additionally, in some embodiments, the carborne device 130 may be configured to provide an alert signal to the train control system. For example, the train control system may be configured to automatically decrease the speed of the train in response to receiving the alert signal.

It should be appreciated that, in some embodiments, an RF worker safety system may include a greater or lesser number of work zone devices 110 than are shown in FIG. 1, and/or may include work zone devices 110 on only a single side of the train track 102. It should also be appreciated that, in some embodiments, a same work zone device 110 may be configured to transmit RF signals to and receive RF signals from the carborne device 130, determine the distance between the work zone device 110 and the carborne device 130, and transmit the alert notification to the portable device 140. In some embodiments, devices described herein may be configured to determine motion characteristics of the carborne device 130, such as a speed, velocity, and/or acceleration of the carborne device 130. For example, the motion characteristics may be determined using multiple determined distances between the carborne device 130 and one or more other devices in the system (e.g., work zone devices, portable devices, etc.)

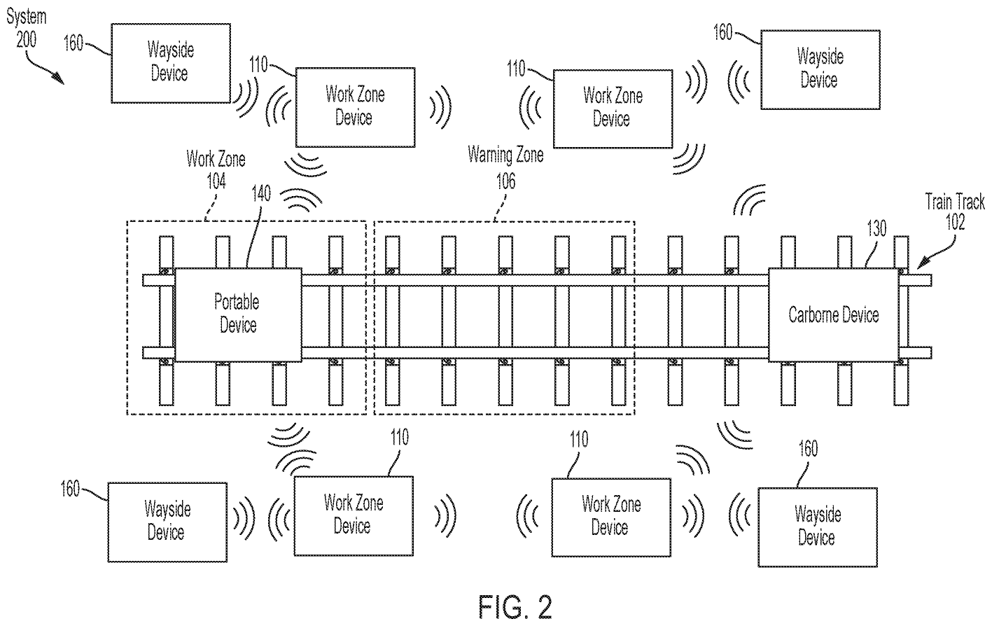

FIG. 2 is a drawing of an illustrative RF worker safety system 200 that includes a plurality of work zone devices 110 and a plurality of wayside devices 160 positioned along a train track 102, a carborne device 130 on a train traveling along the train track 102, and a portable device 140, in accordance with some embodiments of the technology described herein. In some embodiments, the wayside devices 160 may have known positions. For example, the known positions of the wayside devices 160 may be stored in memory (e.g., a non-volatile storage device) that is accessible to the work zone devices 110, the carborne device 130, the portable device 140, and/or other devices in the system 200. By contrast, in some embodiments, the work zone devices 110 may not have known positions. For example, positions of the work zone devices may not be stored in memory that is accessible to the work zone devices 110, the carborne device 130, the portable device 140, and/or other devices in the system, such as when the work zone devices 110 have been deployed temporarily and positions of the work zone devices 110 have not been determined. In some embodiments, the wayside devices 160 may be configured to communicate with the work zone devices 110, the carborne device 130, and/or the portable device 140 using RF signals. In some embodiments, at least one processor of the system 200 may be configured to determine a position of one or more devices in the system 200 using RF signals transmitted to and/or received from the wayside devices 160 and the known positions of the wayside devices 160. For example, the processor(s) may be included in one or more of the work zone devices 110, the wayside devices 160, the carborne device 130, and/or the portable device 140.

In some embodiments, at least one of the work zone devices 110 may be configured to transmit RF signals to and receive RF signals from at least one of the wayside devices 160. In some embodiments, the work zone device 110 may be configured to transmit a first RF signal to the wayside device 160 and receive a second RF signal from the wayside device 160. In some embodiments, the work zone device 110 may be configured to receive the first RF signal from the wayside device 160 and transmit the second RF signal to the wayside device 160. In some embodiments, the RF signals may be UWB signals such as described herein including with reference to FIG. 1. In some embodiments, other devices of the system 200 (e.g., the carborne device 130 and/or the portable device 140) may be configured to transmit RF signals to and receive RF signals from the wayside devices 160 as described herein for the work zone devices 110.

In some embodiments, processor(s) of the system 200 may be configured to determine a position of at least one of the work zone devices 110 using the RF signals transmitted to and/or received from at least one of the wayside devices 160 and the known position(s) of the wayside device(s) 160. In some embodiments, the processor(s) may be configured to determine the position of the work zone device 110 using a time of arrival of a second RF signal transmitted from the work zone device 110 to a wayside device 160 or from the wayside device 160 to the work zone device 110. For example, the processor(s) may be configured to compare the time of arrival of the second RF signal to a time of transmission of the first RF signal. Alternatively or additionally, the processor(s) may be configured to compare times of arrival of second RF signals received by the work zone device 110 from multiple wayside devices 160, and/or times of arrival of second RF signals received by the multiple wayside devices 160 from the work zone device 110. In some embodiments, the processor(s) may be configured to determine the position of the work zone device 110 using information obtained via processing the second RF signal(s). In some embodiments, the processor(s) may be coupled to a memory storing the known position(s) of the wayside device(s) 160 that transmitted or received the second RF signals. For example, a work zone device 110 and/or a wayside device 160 may include a first processor of the system 200 that is configured to determine the position of the work zone device 110 using the second RF signal(s) and the known position(s) of the wayside device(s) 160 that transmitted or received the second RF signal(s).

Alternatively or additionally, in some embodiments, at least one of the wayside devices 160 may be configured to determine the position of the work zone device 110 and/or the carborne device 130, at least in part, by transmitting a first RF signal to the carborne device 130 and receiving a second RF signal from the carborne device 130. For example, the wayside device 160 may be configured to determine the position of the work zone device 110 using the determined distance from the wayside device 160 to the carborne device 130 and the known position of the wayside device 160.

In some embodiments, at least one of the work zone devices 110 and/or at least one of the wayside devices 160 may be configured to alert a worker associated with the portable device 140 in response to determining a distance between the carborne device 130 and the work zone device 110. For example, the work zone device 110 and/or the wayside device(s) 160 may be configured to determine the distance between the work zone device 110 and the carborne device 130, at least in part, by determining a position of the work zone device 110 and of the carborne device using RF signals transmitted between the wayside device(s) 160 and the work zone device 110 and between the wayside device(s) 160 and the carborne device 130 as described herein. Alternatively or additionally, the work zone device 110 may be configured to determine the distance between the work zone device 110 and the carborne device 130 as described herein including with reference to FIG. 1. In some embodiments, the work zone device 110 may be configured to transmit an alert notification to the portable device 140 to alert the worker as described herein including with reference to FIG. 1. In some embodiments, one or more of the wayside devices 160 may serve as intermediate devices via which the work zone device(s) 110 transmit an alert notification to the portable device 140.

In some embodiments, the carborne device 130 may be configured to alert an operator of the train and/or a control system onboard the train in response to determining the distance between the work zone device 110 and the carborne device 130, as described herein including with reference to FIG. 1.

It should be appreciated that some embodiments may include a greater or lesser number of wayside devices 160 than are shown in FIG. 1, and/or may include wayside devices 160 positioned only on one side of the train track 102.

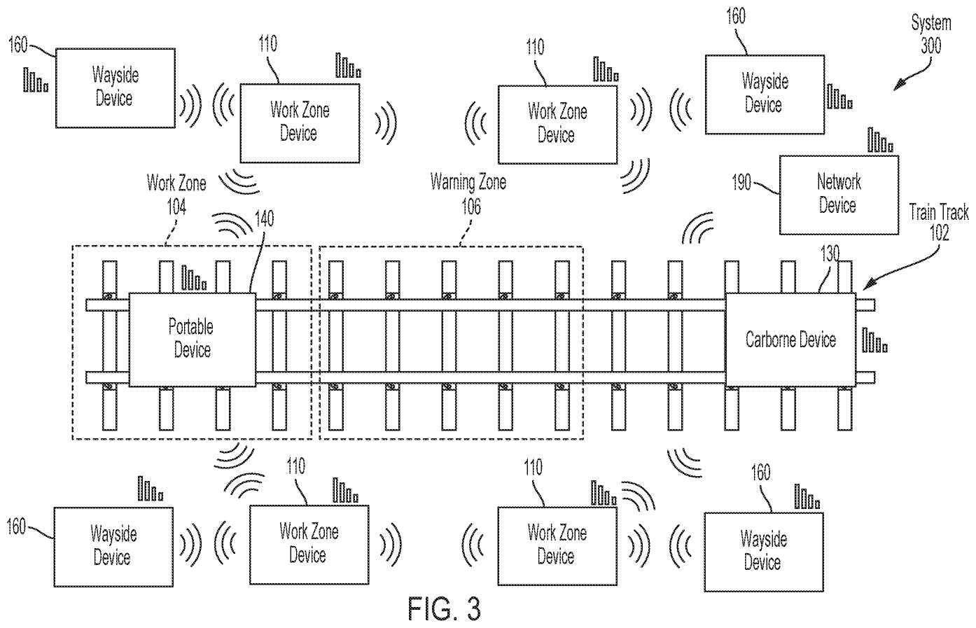

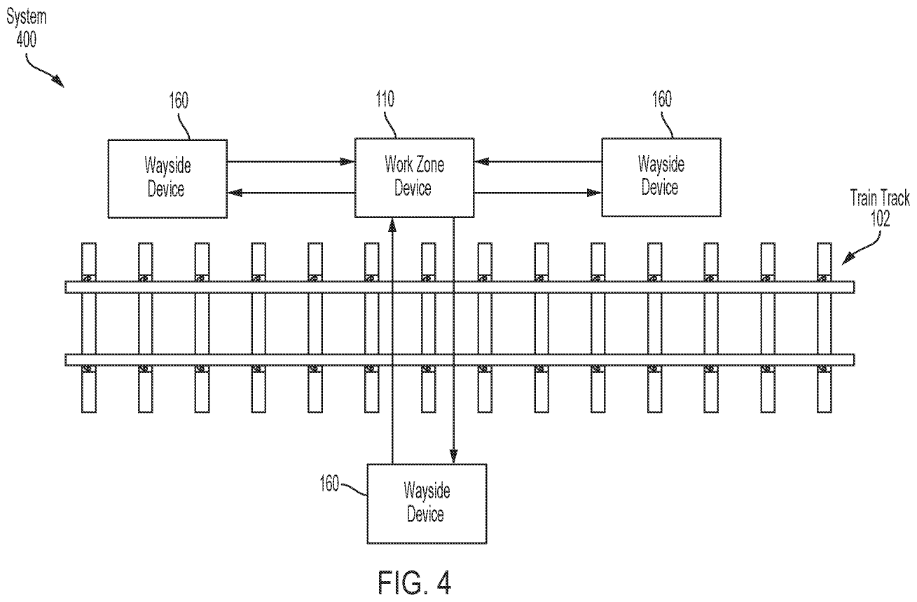

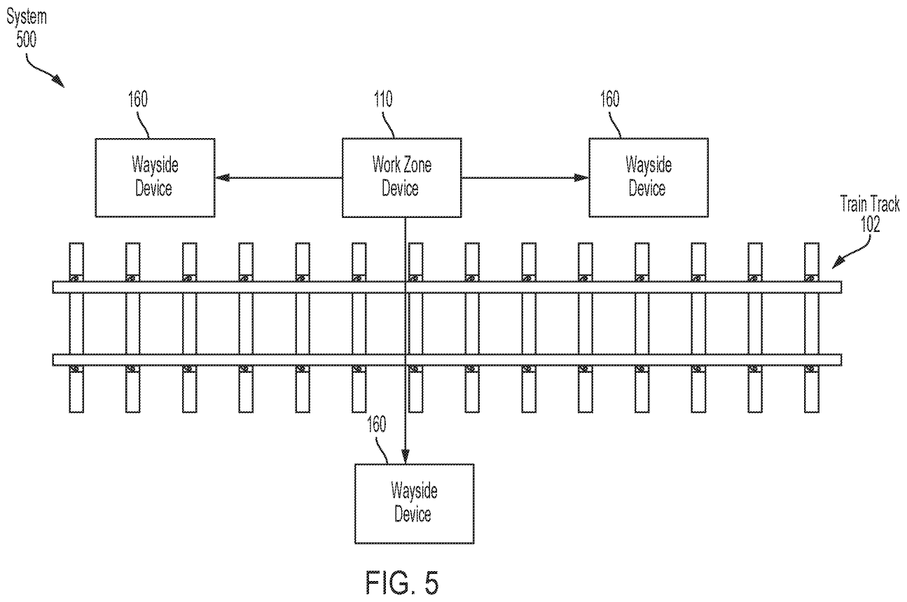

FIG. 3 is a drawing of an illustrative RF worker safety system 300 that includes a plurality of work zone devices 110 and a plurality of wayside devices 160 positioned along a train track 102, a carborne device 130 on a train traveling along the train track 102, a portable device 140, and a network device 190, in accordance with some embodiments of the technology described herein. In some embodiments, the work zone devices 110, the wayside devices 160, the carborne device 130, and/or the portable device 140 may be configured to communicate with the network device 190 over a communication network (e.g., WiFi, Bluetooth, etc.). For example, the network device 190 may be a computer system (e.g., a server) configured to receive position data from and provide position data to the devices of the system 300. In some embodiments, at least one of the work zone devices 110 and/or wayside devices 160 may be configured to transmit RF signals to one another and determine relative position information of the work zone device(s) 110 using the RF signals and provide the relative position information to the network device 190, and the network device 190 may be configured to determine the position of the work zone device(s) 110 using the relative position information, as described further herein including with reference to FIGS. 4-5. In some embodiments, the work zone device(s) 110 may be configured to transmit the alert notification to the portable device 140 over the network. In some embodiments, the network device 190 may be configured to provide positions of the work zone device 110, the portable device 140, and/or the carborne device 130 to a remote device over the network for displaying to a user. For example, the remote device may be a computer system in a train control center, the portable device 140, or the carborne device 130.

FIG. 4 is a drawing of an illustrative RF worker safety system 400 that includes a work zone device 110 and a plurality of wayside devices 160 positioned along a train track 102, with RF signals transmitted between the work zone device 110 and the plurality of wayside devices 160, in accordance with some embodiments of the technology described herein. As shown in FIG. 4, the work zone device 110 may be configured to transmit RF signals to and receive RF signals from the wayside devices 160. In some embodiments, the work zone device 110 and/or the wayside devices 160 may be configured to determine a position of the work zone device 110 using the RF signals transmitted between the work zone device 110 and the wayside devices 160. In some embodiments, the RF signals may be UWB signals, such as described herein including with reference to FIG. 1.

In some embodiments, the work zone device 110 may be configured to transmit first RF signals to the wayside devices 160, receive second RF signals from the wayside devices 160, and determine the position of the work zone device 110 using the second RF signals received from the wayside devices 160. For example, the work zone device 110 may be configured to determine a distance between the work zone device 110 and each wayside device 160 by comparing the time of arrival of the second RF signal received from the wayside device 160 with the time of transmission of the first RF signal sent to the wayside device 160. In some embodiments, the work zone device 110 may be configured to determine relative position information of the work zone device 110 using the second RF signals received from the wayside devices 160. In some embodiments, the work zone device 110 may include and/or may be coupled to a memory storing known positions of the wayside devices 160, and the work zone device 110 may be configured to determine the position of the work zone device 110 using the relative position information and the known positions of the wayside devices 160. In some embodiments, the work zone device 110 may be configured to provide the relative position information to a network device (e.g., network device 190 of FIG. 3). For example, the network device 190 may include and/or may be coupled to a memory storing the known positions of the wayside devices 160, and the network device may be configured to determine the position of the work zone device 110 using the relative position information and the known positions of the wayside devices 160.

In some embodiments, the wayside devices 160 may be configured to transmit first RF signals to the work zone device 110, receive second RF signals from the work zone device 110, and determine the position of the work zone device 110 using the second RF signals received from the work zone device 110. For example, each wayside device 160 may be configured to determine a distance between the work zone device 110 and the wayside device 160 by comparing the time of arrival of the second RF signal received from the work zone device 110 with the time of transmission of the first RF signal sent to the work zone device 110. In some embodiments, the wayside devices 160 may be configured to determine relative position information of the work zone device 110 using the second RF signals received from the work zone device 110. In some embodiments, the wayside devices 160 may include and/or may be coupled to a memory storing known positions of the wayside devices 160, and the wayside devices 160 may be configured to determine the position of the work zone device 110 using the relative position information and the known positions of the wayside devices 160. In some embodiments, the wayside devices 160 may be configured to provide the relative position information to a network device. For example, the network device 190 may include and/or may be coupled to a memory storing the known positions of the wayside devices 160, and the network device may be configured to determine the position of the work zone device 110 using the relative position information and the known positions of the wayside devices 160.

In some embodiments, the work zone device 110 and/or the wayside devices 160 may be configured to determine the position of the work zone device 110 with a precision of less than 50 cm, such as less than 20 cm, less than 10 cm, or less than 5 cm, in a direction along the train track 102. For example, at least two of the wayside devices 160 may be positioned along a line alongside at least a portion of the track 102, and the direction may be along the line. Alternatively or additionally, at least three of the wayside devices 160 may be positioned along a curve alongside at least a portion of the track 102, and the direction may be along a line that approximates the curve. In some embodiments, the work zone device 110 may be configured to determine the position of the work zone device 110 with a precision of less than 5 meters (m), such as less than 3 m or less than 2 m, in a direction perpendicular to the direction along the train track 102. In some embodiments, the work zone device 110 and/or the wayside device(s) 160 may be configured to determine the position of the work zone device 110 in at least two dimensions. For example, using RF signals transmitted and/or received using at least two wayside devices 160 having known positions, the position of the work zone device 110 may be determined using at least two distances between the work zone device 110 and the wayside devices, respectively.

It should be appreciated that some embodiments may include one or more devices (e.g., portable devices, carborne devices, etc.) in addition to or in place of the work zone device 110, and positions of the other device(s) may be determined using first and second RF signals transmitted between the device(s) and the wayside devices 160, as described herein for determining the position of the work zone device 110.

FIG. 5 is a drawing of an illustrative RF worker safety system 500 that includes a work zone device 110 and a plurality of wayside devices 160 positioned along a train track 102, with RF signals transmitted from the work zone device 110 to the plurality of wayside devices 160, in accordance with some embodiments of the technology described herein. As shown in FIG. 5, the work zone device 110 may be configured to transmit first RF signals to the wayside devices 160. Alternatively or additionally, in some embodiments, the wayside devices 160 may be configured to transmit the first RF signals to the work zone device 110. In some embodiments, the work zone device 110 and/or the wayside devices 160 may be configured to determine the position of the work zone device 110 using the first RF signals. In some embodiments, the first RF signals may be UWB signals, such as described herein including with reference to FIG. 1.

In some embodiments, the work zone device 110 may be configured to transmit the first RF signals to the wayside devices 160, and the wayside devices 160 may be configured to determine the position of the work zone device 110 using the first RF signals. In some embodiments the wayside devices 160 may be configured to determine relative position information of the work zone device 110 using the arrival times of the first RF signals. For example, the work zone device 110 may be configured to transmit the first RF signals at the same time, and the wayside devices 160 may be configured to determine the relative position information of the work zone device 110 using the arrival times of the first RF signals at the wayside devices 160. In this example, the wayside devices 160 may be synchronized, such that a difference between the arrival times of the first RF signals indicates a difference in distances between the work zone device 110 and the wayside devices 160. In this example, the wayside devices 160 may be configured to determine the relative position information using time difference of arrival (TDOA) techniques. In some embodiments, the wayside devices 160 may include and/or be coupled to a memory storing the known positions of the wayside devices 160 and may be configured to determine the position of the work zone device 110 using the relative position information and the known positions. In some embodiments, the wayside devices 160 may be configured to provide the relative position information to a network device (e.g., network device 190 in FIG. 3) over a network. For example, the network device may include and/or be coupled to a memory storing the known positions of the wayside devices 160 and may be configured to determine the position of the work zone device 110 using the relative position information and the known positions.

In some embodiments, the wayside devices 160 may be configured to transmit the first RF signals to the work zone device 110, and the work zone device 110 may be configured to determine the position of the work zone device 110 using the first RF signals. In some embodiments the work zone device 110 may be configured to determine relative position information of the work zone device 110 using the arrival times of the first RF signals. For example, the wayside devices 160 may be configured to transmit the first RF signals at the same time, and the work zone device 110 may be configured to determine the relative position information of the work zone device 110 using the arrival times of the first RF signals. In this example, the wayside devices 160 may be synchronized, such that a difference between the arrival times of the first RF signals indicates a difference in distances between the work zone device 110 and the wayside devices 160. In this example, the work zone device 110 may be configured to determine the relative position information using inverse-TDOA (iTDOA) techniques. In some embodiments, the work zone device 110 may include and/or be coupled to a memory storing the known positions of the wayside devices 160 and may be configured to determine the position of the work zone device 110 using the relative position information and the known positions. In some embodiments, the work zone device 110 may be configured to provide the relative position information to a network device (e.g., network device 190 in FIG. 3) over a network. For example, the network device may include and/or be coupled to a memory storing the known positions of the wayside devices 160 and may be configured to determine the position of the work zone device 110 using the relative position information and the known positions.

It should be appreciated that some embodiments may include one or more devices (e.g., portable devices, carborne devices, etc.) in addition to or in place of the work zone device 110, and positions of the other device(s) may be determined using first RF signals transmitted between the device(s) and the wayside devices 160, as described herein for determining the position of the work zone device 110.

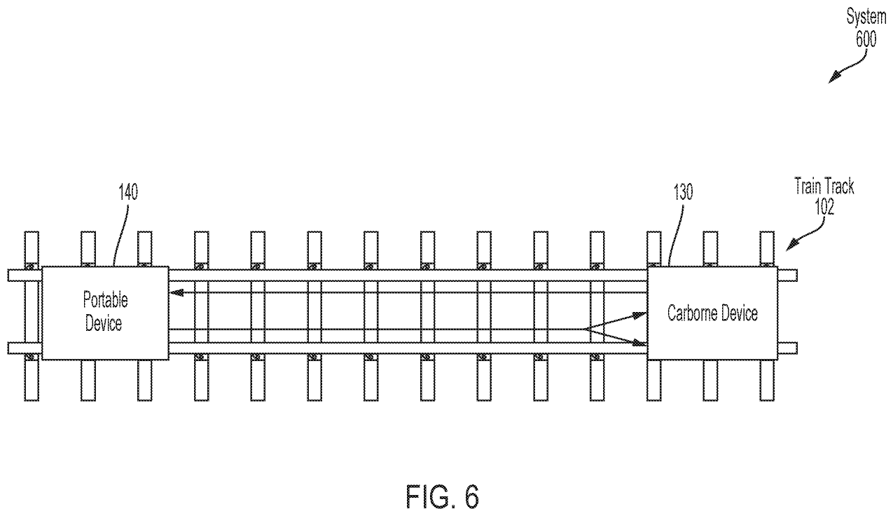

FIG. 6 is a drawing of an illustrative RF worker safety system 600 that includes a portable device 140 and a carborne device 130 on a train traveling along a train track 102, with RF signals transmitted between the portable device 140 and the carborne device 130, in accordance with some embodiments of the technology described herein. As shown in FIG. 6, the carborne device 130 may be configured to transmit a first RF signal to the portable device 140 and receive at least one second RF signal from the portable device 140 in response. Alternatively or additionally, in some embodiments, the portable device may be configured to transmit the first RF signal to the carborne device and receive the second RF signal from the carborne device. In some embodiments, the carborne device 130 and/or the portable device 140 may be configured to determine a position of the portable device 140 using the RF signals transmitted between the carborne device 130 and the portable device 140. In some embodiments, the RF signals may be UWB signals, such as described herein including with reference to FIG. 1.

In some embodiments, the carborne device 130 may be configured to transmit a first RF signal to the portable device 140, receive a second RF signal from the portable device 140, and determine a distance between the carborne device 130 and the portable device 140. In some embodiments, the carborne device 130 may be configured to determine relative position information of the portable device 140 using a time of arrival of the second RF signal. For example, the carborne device 130 may be configured to compare a time of arrival of the second RF signal(s) to a time of transmission of the first RF signal to determine the relative position information. In some embodiments, the carborne device 130 may be configured to determine angular position information of the portable device 140 and determine the relative position information using the angular position information. For example, the carborne device 130 may be configured to receive the second RF signal(s) at multiple antennas and determine a difference in arrival time between the second RF signals received by a first antenna and a second antenna, with the difference in the arrival times providing the angular position information. In this example, the carborne device 130 may be configured to determine the angular position information using angle of arrival (AOA) techniques. In some embodiments, the carborne device 130 may be configured to provide the relative position information and/or the angular position information of the portable device 140 to a network device (e.g., network device 190 in FIG. 3) over a network to determine the position of the portable device 140. For example, the network device may be configured to determine the position of the portable device 140 using a known and/or determined position of the carborne device 130 (e.g., using one or more wayside devices 160). In some embodiments, the carborne device 130 may be configured to determine the position of the portable device 140 using a known and/or determined position of the carborne device 130 stored in a memory coupled to and/or included in the carborne device.

In some embodiments, the portable device 140 may be configured to transmit a first RF signal to the carborne device 130, receive a second RF signal from the carborne device 130, and determine a distance between the carborne device 130 and the portable device 140. In some embodiments, the portable device 130 may be configured to determine relative position information of the portable device 140 using a time of arrival of the second RF signal. For example, the portable device 140 may be configured to compare a time of arrival of the second RF signal(s) to a time of transmission of the first RF signal to determine the relative position information. In some embodiments, the portable device 140 may be configured to provide the relative position information of the portable device 140 to a network device (e.g., network device 190 in FIG. 3) over a network to determine the position of the portable device 140. For example, the network device may be configured to determine the position of the portable device 140 using a known and/or determined position of the carborne device 130 (e.g., using one or more wayside devices 160). In some embodiments, the portable device 140 may be configured to determine the position of the portable device 140 using a known and/or determined position of the carborne device 130 stored in a memory coupled to and/or included in the portable device 140.

It should be appreciated that some embodiments include one or more work zone devices in place of or in addition to the portable device 140 and/or the carborne device 130, and the positions of the work zone device(s) may be determined using RF signals transmitted between the work zone device(s) and the portable device 140, the carborne device 130, and/or other work zone device(s) in the manner described herein for determining the position of the portable device 140.

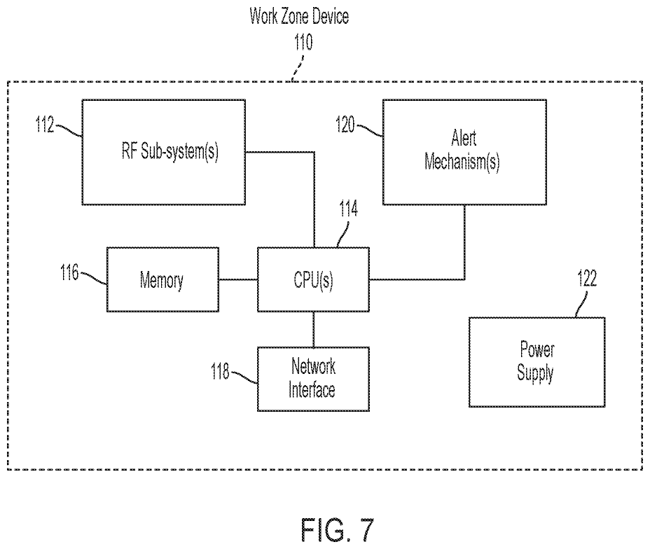

FIG. 7 is a drawing of an illustrative work zone device 110 that may be included in an RF worker safety system, in accordance with some embodiments of the technology described herein. As shown in FIG. 7, the work zone device 110 includes an RF sub-system 112 coupled to one or more processors 114, with the processor(s) 114 coupled to a memory 116, a network interface, and one or more alert mechanisms 120. The work zone device 110 further includes a power supply 122 configured to provide power to the components of the work zone device 110. In some embodiments, the work zone device 110 may be configured for temporary placement in or near a work zone. For example, the power supply 122 may be configured to receive power from an electrical outlet and provide the power to the components of the work zone device 110.

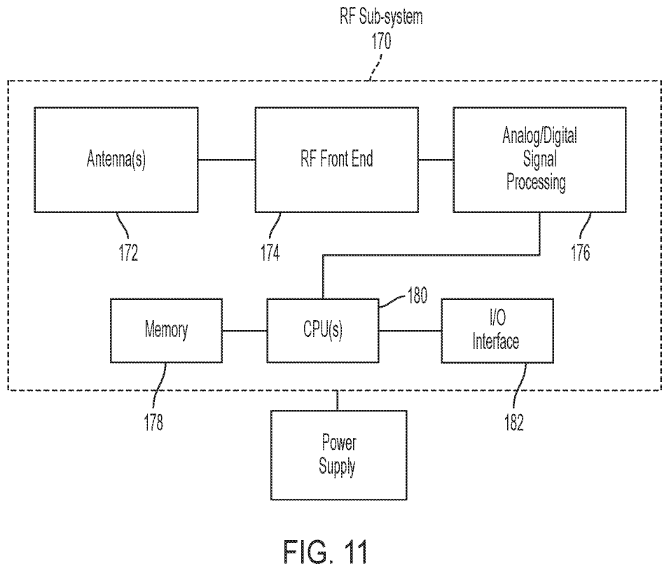

In some embodiments, the RF sub-system 112 may include one or more RF antennas configured to transmit and/or receive UWB signals, such as the first and second RF signals described herein including with reference to FIGS. 1-6, transmit and/or receive circuitry, signal processing circuitry, and/or one or more processors configured to control transmission and/or reception of RF signals via the antenna(s). The RF sub-system 112 is described further herein including with reference to FIG. 11.

In some embodiments, the processor(s) 114 may be configured to determine a distance between the work zone device 110 and a second device (e.g., a carborne device, a portable device, or a wayside device) using RF signals transmitted to and/or received from the second device via the RF sub-system 112. For example, the processor(s) 114 may be configured to determine whether the second device is within a predetermined threshold distance using an RF signal received from the second device. In some embodiments, in response to the RF sub-system 112 receiving a first RF signal from a second device, the processor(s) 114 may be configured to cause the RF sub-system 112 to transmit a second RF signal to the second device.

In some embodiments, the processor(s) 114 may be configured to determine a position of the work zone device 110 using RF signals received from one or more wayside devices. In this example, the processor(s) 114 may be configured to determine relative position information of the work zone device 110 using a time of arrival of the RF signal(s). In some embodiments, the memory 116 may be configured to store the known position(s) of the wayside device(s), and the processor(s) 114 may be configured to determine the position of the work zone device 110 using the relative position information and the known position(s). In some embodiments, the processor(s) 114 may be configured to transmit the relative position information to a network device over a network via the network interface 118. For example, the network device may include or may be coupled to a memory storing the known position(s) of the wayside device(s), and may be configured to determine the position of the work zone device 110 using the relative position information and the known position(s).

In some embodiments, the processor(s) 114 may be configured to cause the alert mechanism(s) 120 to alert a worker in a work zone in response to determining a distance between the work zone device 110 and a second device. For example, the alert mechanism(s) 120 may include a light (e.g., a strobe light) that may be flashed, a speaker that may provide an audio alert, a haptic device that may vibrate, and/or a display that may be display alert content in response to signals received from the processor(s) 114. In some embodiments, the processor(s) 114 may be configured to cause the RF sub-system 112 to transmit an alert notification to a second device (e.g., a portable device or a carborne device) in response to determining the distance between the work zone device 110 and the second device.

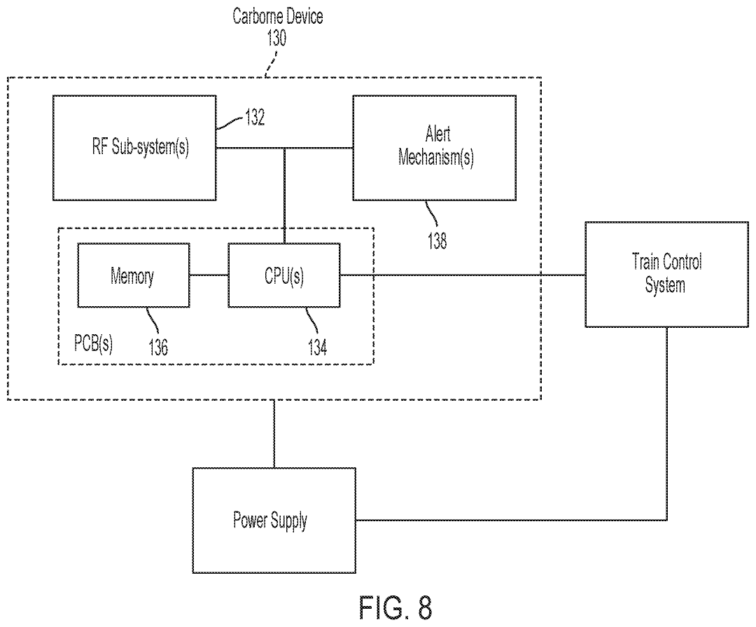

FIG. 8 is a drawing of an illustrative carborne device 130 that may be included in an RF worker safety system, in accordance with some embodiments of the technology described herein. As shown in FIG. 8, the carborne device 130 includes an RF sub-system 132, one or more processors 134 coupled to a memory 136, with the processor(s) 134 and the memory 136 positioned on one or more printed circuit boards (PCBs), and one or more alert mechanisms 138. The carborne device 130 may be positioned on a train. For example, as shown in FIG. 8, the carborne device 130 is coupled to a power supply and a train control system, and the power supply may be configured to provide power to the carborne device and the train control system.

In some embodiments, the RF sub-system 132 may include one or more RF antennas configured to transmit and/or receive UWB signals, such as the first and second RF signals described herein including with reference to FIGS. 1-6, transmit and/or receive circuitry, signal processing circuitry, and/or one or more processors configured to control transmission and/or reception of RF signals via the antenna(s). The RF sub-system 132 is described further herein including with reference to FIG. 11.

In some embodiments, the processor(s) 134 may be configured to determine a distance between the carborne device 130 and a second device (e.g., a work zone device, a portable device, or a wayside device) using RF signals transmitted to and/or received from the second device via the RF sub-system 132. For example, the processor(s) 134 may be configured to determine whether the second device is within a predetermined threshold distance using an RF signal received from the second device. In some embodiments, in response to the RF sub-system 132 receiving a first RF signal from a second device, the processor(s) 134 may be configured to cause the RF sub-system 132 to transmit a second RF signal to the second device. In some embodiments, the processor(s) 134 may be configured to determine angular position information of the second device using RF signals received by multiple antennas of the RF sub-system 132, as described herein.

In some embodiments, the processor(s) 134 may be configured to determine a position of the carborne device 130 using RF signals received from one or more wayside devices. In this example, the processor(s) 134 may be configured to determine relative position information of the carborne device 130 using a time of arrival of the RF signal(s). In some embodiments, the memory 136 may be configured to store the known position(s) of the wayside device(s), and the processor(s) 134 may be configured to determine the position of the carborne device 130 using the relative position information and the known position(s). In some embodiments, the processor(s) 134 may be configured to transmit the relative position information to a network device over a network via a network interface of the carborne device 130. For example, the network device may include or may be coupled to a memory storing the known position(s) of the wayside device(s), and may be configured to determine the position of the carborne device 130 using the relative position information and the known position(s).

In some embodiments, the processor(s) 134 may be configured to cause the alert mechanism(s) 138 to alert an operator of the train in response to determining a distance between the carborne device 130 and a second device. For example, the alert mechanism(s) 138 may include a light that may be flashed, a speaker that may provide an audio alert, a haptic device that may vibrate, and/or a display that may display alert content in response to signals received from the processor(s) 134. In some embodiments, the processor(s) 134 may be configured to cause the RF sub-system 132 to transmit an alert notification to a second device (e.g., a portable device) in response to determining the distance between the carborne device 130 and the second device. In some embodiments, the processor(s) 134 may be configured to provide an alert signal to the train control system of the train in response to determining the distance between the carborne device 130 and the second device, which may cause the train control system to decrease the speed of the train.

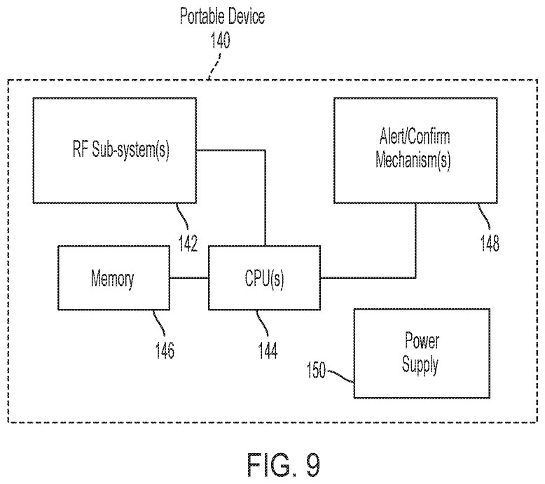

FIG. 9 is a drawing of an illustrative portable device 140 that may be included in an RF worker safety system, in accordance with some embodiments of the technology described herein. As shown in FIG. 9, the portable device 140 includes an RF sub-system 142 coupled to one or more processors 144, with the processor(s) 144 coupled to a memory 146 and one or more alert mechanisms 148. The portable device 140 further includes a power supply 150 configured to provide power to the components of the portable device 140. In some embodiments, the portable device 140 may be configured to be worn and/or carried by a worker. For example, the power supply 150 may include a battery (e.g., a rechargeable battery) configured to provide power to the components of the portable device 140.

In some embodiments, the RF sub-system 112 may include one or more RF antennas configured to transmit and/or receive UWB signals, such as the first and second RF signals described herein including with reference to FIGS. 1-6, transmit and/or receive circuitry, signal processing circuitry, and/or one or more processors configured to control transmission and/or reception of RF signals via the antenna(s). The RF sub-system 112 is described further herein including with reference to FIG. 11. In some embodiments, the portable device 140 may be configured to only transmit RF signals in response to receiving RF signals from another device thereby conserving power.

In some embodiments, the processor(s) 144 may be configured to determine a distance between the portable device 140 and a second device (e.g., a carborne device, a work zone device, or a wayside device) using RF signals transmitted to and/or received from the second device via the RF sub-system 112. For example, the processor(s) 114 may be configured to determine whether the second device is within a predetermined threshold distance using an RF signal received from the second device. In some embodiments, in response to the RF sub-system 142 receiving a first RF signal from a second device, the processor(s) 144 may be configured to cause the RF sub-system 142 to transmit a second RF signal to the second device.

In some embodiments, the processor(s) 144 may be configured to determine a position of the portable device 140 using RF signals received from one or more wayside devices. In this example, the processor(s) 144 may be configured to determine relative position information of the portable device 140 using a time of arrival of the RF signal(s). In some embodiments, the memory 146 may be configured to store the known position(s) of the wayside device(s), and the processor(s) 144 may be configured to determine the position of the portable device 140 using the relative position information and the known position(s). In some embodiments, the processor(s) 144 may be configured to transmit the relative position information to a network device over a network via a network interface. For example, the network device may include or may be coupled to a memory storing the known position(s) of the wayside device(s), and may be configured to determine the position of the work zone device 110 using the relative position information and the known position(s).

In some embodiments, the processor(s) 144 may be configured to cause the alert mechanism(s) 148 to alert a worker in response to determining a distance between the portable device 140 and a second device, and/or in response to receiving an alert notification from a work zone device. For example, the alert mechanism(s) 148 may include a light that may be flashed, a speaker that may provide an audio alert, a haptic device that may vibrate, and/or a display that may display alert content in response to signals received from the processor(s) 134. In some embodiments, portable device 140 may be configured to prompt the worker for input (e.g., using the light, speaker, haptic device, and/or display), and may be configured to receive the input via one or more input devices such as a button or a touch screen. In some embodiments, the processor(s) 134 may be configured to cause the RF sub-system 132 to transmit a confirmation notification to a second device (e.g., a work zone device or a carborne device) in response receiving input from the worker confirming the alert.

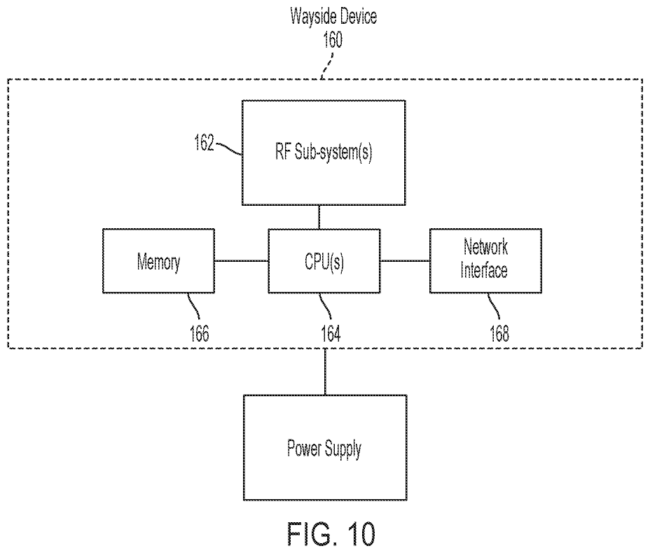

FIG. 10 is a drawing of an illustrative wayside device 160 that may be included in an RF worker safety system, in accordance with some embodiments of the technology described herein. As shown in FIG. 10, the wayside device 160 includes an RF sub-system 162 coupled to one or more processors 164, with the processor(s) 164 coupled to a memory 166 and a network interface 168. The wayside device 160 is coupled to a power supply that is configured to provide power to the components of the wayside device 160. In some embodiments, the work zone device 110 may be configured for permanent placement along a train track. For example, the power supply may be a dedicated power source configured to provide power to the components of the wayside device 160.

In some embodiments, the RF sub-system 162 may include one or more RF antennas configured to transmit and/or receive UWB signals, such as the first and second RF signals described herein including with reference to FIGS. 1-6, transmit and/or receive circuitry, signal processing circuitry, and/or one or more processors configured to control transmission and/or reception of RF signals via the antenna(s). The RF sub-system 162 is described further herein including with reference to FIG. 11.

In some embodiments, the processor(s) 164 may be configured to determine a position of a second device (e.g., a work zone device, a portable device, or a carborne device) using RF signals received from the second device. In this example, the processor(s) 164 may be configured to determine relative position information of the second device using a time of arrival of the RF signal(s). In some embodiments, the memory 166 may be configured to store the known position of the wayside device 160, and the processor(s) 164 may be configured to determine the position of the second device using the relative position information and the known position(s). In some embodiments, the processor(s) 164 may be configured to transmit the relative position information to a network device over a network via the network interface 168. For example, the network device may include or may be coupled to a memory storing the known position of the wayside device 160, and may be configured to determine the position of the second device using the relative position information and the known position.

In some embodiments, in response to the RF sub-system 162 receiving an RF signal from a second device, the processor(s) 164 may be configured to cause the RF sub-system 162 to transmit an RF signal to the second device.

FIG. 11 is a drawing of an illustrative RF sub-system 170 that may be included in an RF worker safety system, in accordance with some embodiments of the technology described herein. In some embodiments, the RF sub-system 170 may be configured to be included in a work zone device, a portable device, a carborne device, or a wayside device, as described herein. As shown in FIG. 11, the RF sub-system 170 includes one or more antennas 172, RF front-end circuitry 174, analog and/or digital processing circuitry 176, one or more processors 180, a memory 178, and an input/output (I/O) interface. The RF sub-system is also shown coupled to a power supply, which may be dedicated to the RF sub-system, or may be configured to provide power to other components of the device that includes the RF sub-system as well.

In some embodiments, the antenna(s) 172 may be configured to transmit and/or receive RF signals, such as UWB signals, as described herein. For example, the antenna(s) 172 may be configured to transmit and/or receive RF signals having a bandwidth of at least 500 MHz, at least 1 GHz, at least 2 GHz, or at least 3 GHz. In this example, the antenna(s) 172 may be configured to transmit and/or receive RF signals in a frequency range within 1 GHz and 10 GHz, such as from 3-5 GHz, from 6-9 GHz, or other frequencies in this range. Alternatively or additionally, in some embodiments, other frequency ranges (e.g., below 1 GHz and/or above 10 GHz) may be used. In some embodiments, multiple antennas 172 may be configured to be positioned at different portions of the device that includes the RF sub-system. For example, the antennas 172 may be positioned far enough from one another that processor(s) 180, and/or processor(s) of the device that includes the antennas 172, may be configured to determine angular position information using RF signals received using different ones of the antenna(s) 172.

In some embodiments, the RF front-end circuitry 174 may include transmit circuitry configured to transmit RF signals to the antenna(s) 172 and/or receive circuitry configured to receive RF signals via the antenna(s) 172. In some embodiments, the transmit circuitry may include modulation circuitry (e.g., one or more mixers and at least one local oscillator) configured to modulate signals to RF and one or more power amplifiers configured to increase the power level of the RF signals for transmission by the antenna(s) 172. In some embodiments, the receive circuitry may include one or more low noise amplifiers configured to increase the power level of RF signals received by the antenna(s) 172 and demodulation circuitry (e.g., one or more mixers and at least one local oscillator) configured to demodulate the signals to baseband for processing.

In some embodiments, the analog and/or digital signal processing circuitry 176 may include phase shift (e.g., time delay) circuitry, Fourier transform circuitry, and/or other suitable circuitry for obtaining information from received RF signals in the time domain and/or in the frequency domain. In some embodiments, the analog and/or digital signal processing circuitry 176 may include analog to digital conversion circuitry configured to sample analog signals and generate signal samples. For example, in some embodiments, at least some signal processing may be performed in the digital domain using digital logic circuitry of one or more field programmable gate arrays (FPGAs) and/or application specific integrated circuits (ASICs). In some embodiments, the signal samples may be provided to the processor(s) 180. In some embodiments, the analog and/or digital signal processing circuitry 176 may include phase shift (e.g., time delay) circuitry and/or analog to digital conversion circuitry configured to convert digital signals received from the processor(s) 180 to analog signals for transmission via the antenna(s) 172.

In some embodiments, the processor(s) 180 may be configured to control transmission, reception, and/or signal processing of the antenna(s), the RF front-end circuitry, and/or the analog and/or digital signal processing circuitry. For example, the processor(s) 180 may be configured to receive processed versions of RF signals received by the antenna(s) 180 via the RF front-end circuitry and the analog and/or digital signal processing circuitry 176. In some embodiments, the processor(s) 180 may be configured to store received signals in the memory 176 and/or load signal information from the memory 176 and provide signals to antenna(s) 172 via the analog and/or digital signal processing circuitry 176 and the RF front-end circuitry 174 for transmission. In some embodiments, the processor(s) 180 may be configured to provide received signals, and/or signals indicative of the received signals, to one or more processors of the device that includes the RF sub-system 170 via the I/O interface 182. In some embodiments, the processor(s) 180 may be configured to determine angular position information using multiple RF signals received using multiple respective ones of the antenna(s) 172, such as using the arrival times of the RF signals and known positions of the antenna(s) 172 (e.g., with the known positions of the antenna(s) 172 stored in the memory 178).

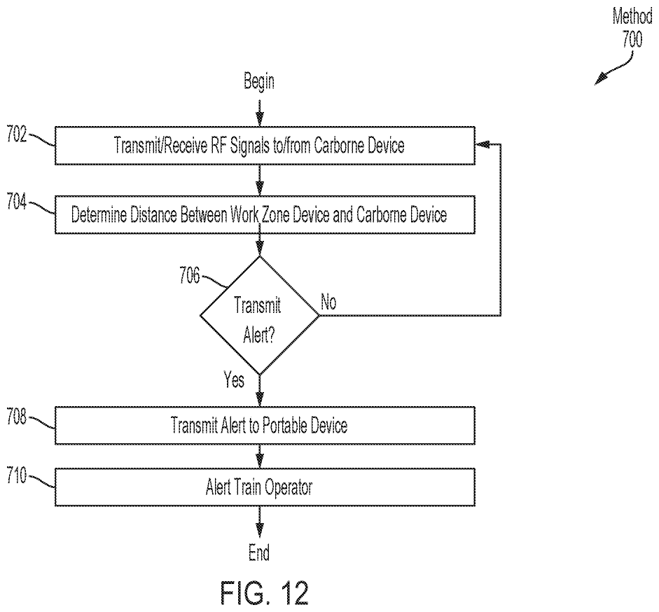

FIG. 12 is a drawing of an illustrative method 700 that may be performed by one or more components of an RF worker safety system, in accordance with some embodiments of the technology described herein. In some embodiments, the method 700 may be performed by a work zone device, such as the work zone device 110 described herein, positioned along a train track. For example, the work zone device may be associated with a work zone and may be configured to transmit RF signals to and/or receive RF signals from a carborne device on a train traveling along the train track, such as described herein including with reference to FIG. 1. In some embodiments, the work zone device may be further configured to communicate with a portable device associated with a worker in the work zone. As shown in FIG. 12, the method 700 includes step 702 of transmitting at least one RF signal to and/or receiving at least one RF signal from a carborne device (e.g., the carborne device 130), step 704 of determining a distance between the work zone device and the carborne device, step 706 of determining whether to transmit an alert notification to a portable device, step 708 of transmitting the alert notification to the portable device when it is determined to transmit the alert notification to the portable device, and step 710 of alerting an operator of a train (e.g., having the carborne device onboard). If it is determined not to transmit the alert notification to the portable device, the method 700 returns to step 702.

In some embodiments, step 702 of transmitting at least one RF signal to and/or receiving at least one RF signal from the carborne device may include receiving, at a work zone device, a first RF signal from the carborne device. For example, the carborne device may periodically transmit first RF signals (e.g., in a direction of travel of the train having the carborne device onboard). In some embodiments, step 702 may further include transmitting a second RF signal from the work zone device to the carborne device. For example, the work zone device may transmit the second RF signal in response to receiving the first RF signal. In some embodiments, the work zone device may wait a predetermined amount of time between receiving the first RF signal and transmitting the second RF signal. In some embodiments, step 702 may include transmitting the first RF signal from the work zone device to the carborne device. For example, the work zone device may periodically transmit first RF signals in a direction along the train track (e.g., in a direction from which trains are expected to travel). In some embodiments, step 702 may further include receiving the second RF signal from the carborne device. For example, the carborne device may transmit the second RF signal in response to receiving the first RF signal.

In some embodiments, step 704 of determining the distance between the work zone device and the carborne device may include determining the distance using the RF signals transmitted between the work zone device and the carborne device. For example, the work zone device may be positioned at the edge of a warning zone and determine that the carborne device is within a predetermined threshold distance of the work zone device, based, at least in part, on receiving a first RF signal from the carborne device. In this example, determining the distance using the RF signals includes using the arrival of at least the first RF signal. In some embodiments, step 704 may include determining the distance using a time of arrival of a second RF signal. For example, the work zone device may compare a time of transmission of the first RF signal with the time of arrival of the second RF signal to determine the distance. In this example, the work zone device may take into account (e.g., subtract) a predetermined amount of time between when the carborne device receives the first RF signal and transmits the second RF signal.

In some embodiments, step 706 of determining whether to transmit the alert notification to a portable device may include determining whether the distance between the work zone device and the carborne device is within a predetermined threshold distance. For example, the work zone device may determine whether the distance is within the predetermined threshold distance based, at least in part, on the arrival of the first RF signal, and/or by determining the distance using the time of arrival of the second RF signal and comparing the determined distance to the predetermined threshold distance.

In some embodiments, step 708 of transmitting the alert notification to the portable device when it is determined to transmit the alert notification to the portable device may include transmitting the alert notification using one or more RF signals and/or over a network. In some embodiments, the work zone device may transmit the alert notification to the portable device via an intermediate device, such as a second work zone device or a network device. For example, the work zone device may be positioned closer to the carborne device than the second work zone device, and the second work zone device may be positioned closer to the portable device, and the work zone device may transmit an indication that the carborne device is within the predetermined distance of the work zone device, causing the second work zone device to transmit the alert notification to the portable device. In some embodiments, the method 700 may further include receiving the alert notification at the portable device and alerting a worker associated with the portable device responsive to receiving the alert notification. For example, the portable device may generate an alert, such as an audio, haptic, and/or visual alert for the worker. In some embodiments, the portable device may receive an input from the worker confirming that the alert was received. For example, the portable device may receive the input via one or more input devices, such as a button and/or touchscreen. In some embodiments, the portable device may transmit a signal to the work zone device indicating that the alert has been confirmed by the worker.

In some embodiments, step 710 of alerting the operator of the train may include transmitting an alert notification that causes the carborne device to generate an alert, such as an audio, haptic, and/or visual alert for the operator of the train. It should be appreciated that some embodiments may not include step 710. For example, the carborne device may instead cause another device on the train to generate the alert, and/or may transmit an alert signal to a train control system of the train that causes the train control system to decrease the speed of and/or stop the train.

In some embodiments, RF signals transmitted by the work zone device, the carborne device, and/or other devices in performing method 700 may be ultra-wideband (UWB) signals, such as RF signals having a bandwidth of at least 500 MHz, at least 1 GHz, or at least 2 GHz (e.g., in a 3-5 GHz or 6-9 GHz frequency range).

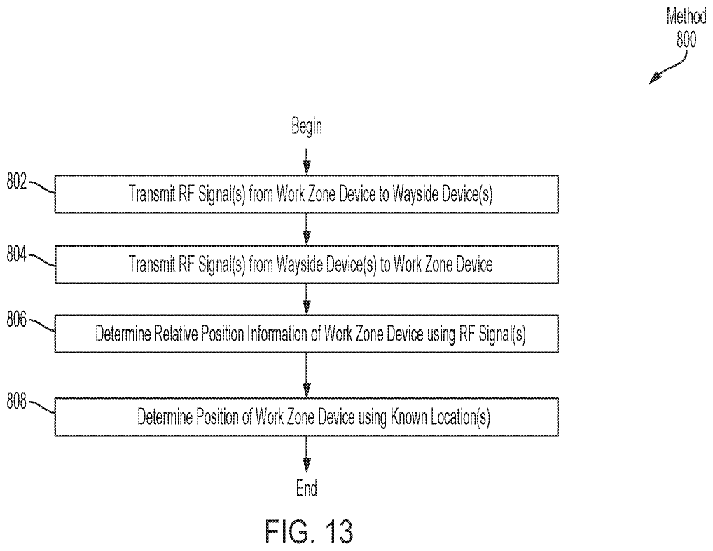

FIG. 13 is a drawing of an illustrative method 800 that may be performed by components of an RF worker safety system, in accordance with some embodiments of the technology described herein. In some embodiments, the method 800 may be performed by a work zone device (e.g., work zone device 110) and a plurality of wayside devices having known positions (e.g., wayside devices 160). For example, the work zone device and wayside devices may be positioned along a train track as described herein including with reference to FIGS. 2-3. As shown in FIG. 13, the method 800 includes step 802 of transmitting RF signals from the work zone device to at least one of the wayside devices, step 804 of transmitting RF signals from at least one of the wayside devices to the work zone device, step 806 of determining relative position information of the work zone device using RF signal(s) transmitted between the work zone device and the wayside device(s), and step 808 of determining the position of the work zone device using the known location(s) of the wayside device(s).

In some embodiments, step 802 of transmitting RF signals from the work zone device to at least one of the wayside devices may be performed before step 804 of transmitting RF signals from at least one of the wayside devices to the work zone device. For example, step 802 may include transmitting one or more first RF signals from the work zone device to the wayside device(s), and step 804 may include transmitting one or more second RF signals from the wayside device(s) to the work zone device. In this example, the wayside device(s) may transmit the second RF signal(s) in response to receiving the first RF signal(s). Some embodiments may not include step 804, such as when the wayside device(s) do not transmit the second RF signal(s) to the work zone device, as described herein.

In some embodiments, step 804 of transmitting RF signals from at least one of the wayside devices to the work zone device may be performed before step 802 of transmitting RF signals from the work zone device to at least one of the wayside devices. For example, step 804 may include transmitting one or more first RF signals from the wayside device(s) to the work zone device, and step 802 may include transmitting one or more second RF signals from the work zone device to the wayside device(s). In this example, the work zone device may transmit the second RF signal(s) in response to receiving the first RF signal(s). Some embodiments may not include step 802, such as when the work zone device does not transmit the second RF signal(s) to the wayside device(s), as described herein.

In some embodiments, step 806 of determining relative position information of the work zone device using RF signal(s) transmitted between the work zone device and the wayside device(s) may include at least one processor determining the relative position information using the RF signal(s). In some embodiments, the work zone device may include the processor(s) that determine the relative position information using arrival times of RF signals received at the work zone device during step 804. For example, step 802 may be performed before step 804, and the processor(s) may determine the relative position information using arrival times of second RF signal(s) received at the work zone device during step 804 by comparing the arrival times to the transmission times of first RF signal(s) transmitted from the work zone device during step 802. In another example, the processor(s) may determine the relative position information using differences between arrival times of multiple first RF signals received at the work zone device during step 804. In this example, the first RF signals may be transmitted from multiple wayside devices at a same time, and step 802 may not be performed.

In some embodiments, at least one of the wayside devices may include the processor(s) that determine the relative position information using arrival times of RF signals received at the wayside device(s) during step 802. For example, step 804 may be performed before step 802, and the processor(s) may determine the relative position information using arrival times of second RF signal(s) received at the wayside device(s) during step 802 by comparing the arrival times to the transmission times of first RF signal(s) transmitted from the wayside device(s) during step 804. In another example, the processor(s) may determine the relative position information using differences between arrival times of multiple first RF signals received at the wayside device(s) during step 802. In this example, the first RF signals may be transmitted from the work zone device at a same time, and step 804 may not be performed. In some embodiments, each wayside device may determine at least a portion of the relative positioning information using at least one RF signal received at the wayside device.

In some embodiments, step 808 of determining the position of the work zone device using the known location(s) of the wayside device(s) may include determining the position of the work zone device using the known location(s) and the relative position information. For example, the processor(s) of the work zone device or the wayside device(s) that determined the relative position information may access the known location(s) of the wayside device(s) in a memory coupled to the processor(s). In another example, the work zone device or the wayside device(s) that determined the relative position information may provide the relative position information to a network device (e.g., network device 190) over a network, and the network device may access the known location(s) of the wayside device(s) in a memory included in or coupled to the network device 190.

In some embodiments, the method 800 may further include providing the position of the work zone device to a remote device over a network (e.g., via a network device). For example, the remote device may be configured to display the position for a user alone or in combination with positions of other devices (e.g., portable devices, work zone devices, wayside devices, and/or carborne devise). In this example, the remote device may be in a control room and the user may be a worker in the control room. Alternatively, the remote device may be a portable device or a carborne device and the user may be a worker in the work zone or an operator of a train with the carborne device onboard.

In some embodiments, the method 800 may further include transmitting an alert notification from the work zone device to a portable device associated with a worker in the work zone, such as described herein including with reference to step 708 of method 700. For example, the portable device may receive the alert notification and provide an alert (e.g., audio, visual, and/or haptic) to the worker in response to receiving the alert notification. In this example, the portable device may receive input from the worker indicating that the alert was received and transmit a signal to the work zone device indicating that the alert has been confirmed.

In some embodiments, the method 800 may further include transmitting RF signals to and/or receiving RF signals from a portable device associated with a worker in the work zone. In some embodiments, the work zone device and/or the wayside device(s) may transmit one or more first RF signal(s) to the portable device and receive one or more second RF signa(s)l from the portable device. In some embodiments, the work zone device and/or the wayside device(s) may determine a position of the portable device using the RF signals transmitted to and from the portable device. For example, the work zone device and/or the wayside device(s) may determine relative position information of the portable device and determine the position of the portable device using the relative position information and a determined position of the work zone device (e.g., using the wayside device(s)) and/or the known position(s) of the wayside device(s). In another example, the work zone device and/or the wayside device(s) may determine and provide the relative position information to a network device that may determine the position of the portable device using a determined position of the work zone device and/or the known position(s) of the wayside device(s). In some embodiments, the portable device may determine the relative position information using multiple first RF signals from the work zone device and/or the wayside device(s) and provide the relative position information to a network device that may determine the position of the portable device as described herein. For example, the portable device may not transmit a second RF signal to the work zone device and/or the wayside device(s). In some embodiments, the portable device may access a memory storing the determined position of the work zone device and/or the known position(s) of the wayside device(s) to determine the position of the portable device.

In some embodiments, RF signals transmitted by the work zone device, the wayside devices, and/or other devices in performing method 800 may be ultra-wideband (UWB) signals, such as RF signals having a bandwidth of at least 500 MHz, at least 1 GHz, or at least 2 GHz (e.g., in a 3-5 GHz or 6-9 GHz frequency range). In some embodiments, the position of the work zone device and/or other devices in the system may be determined with a precision of less than 50 cm, less than 20 cm, less than 10 cm, or less than 5 cm in a direction along the train track. In some embodiments, the position of the work zone device and/or other devices in the system may be determined with a precision of less than 5 meters (m), such as less than 3 m or less than 2 m, in a direction perpendicular to the direction along the train track.

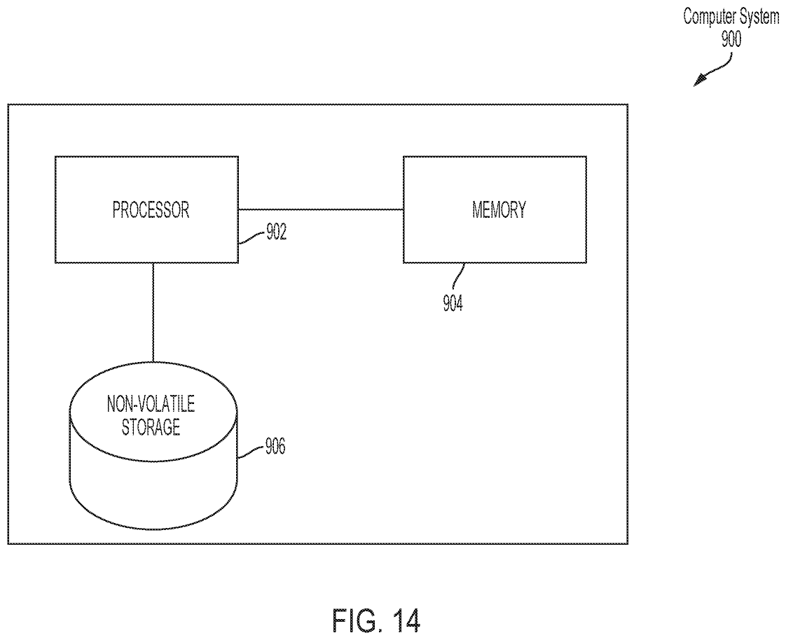

FIG. 14 is a diagram of an illustrative computer system 900 on which embodiments described herein may be implemented. For example, processes described with reference to FIGS. 13-14 may be implemented using computer system 900. As another example, the computer system 900 may be used to perform some of the determinations described herein in connection with the network device 190 including with reference to FIG. 3. The computer system 900 may include one or more processors 902 and one or more articles of manufacture that comprise non-transitory computer-readable storage media (e.g., memory 904 and one or more non-volatile storage media 906). The processor 902 may control writing data to and reading data from the memory 904 and the non-volatile storage device 906 in any suitable manner, as the aspects of the disclosure provided herein are not limited in this respect. To perform any of the functionality described herein, the processor 902 may execute one or more processor-executable instructions stored in one or more non-transitory computer-readable storage media (e.g., the memory 904), which may serve as non-transitory computer-readable storage media storing processor-executable instructions for execution by the processor 902.

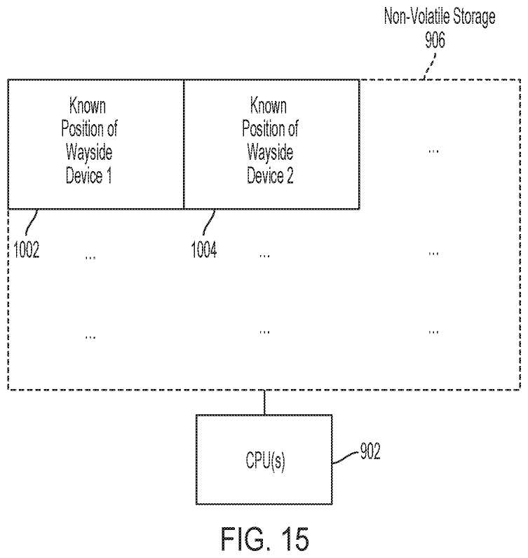

FIG. 15 is a drawing of non-volatile storage device 906 that may be included an RF worker safety subsystem, in accordance with some embodiments of the technology described herein. In some embodiments, the non-volatile storage 906 may be included in one or more devices described herein, such as work zone devices, portable devices, wayside devices, and carborne devices. As shown in FIG. 15, the non-voltage storage device 906 is coupled to the processor(s) 902 of the computer system 900 shown in FIG. 14. The non-volatile storage device 906 stores a first known position 1002 of a first wayside device and a second known position 1004 of a second wayside device. The non-volatile storage device 906 may store known positions of other devices in the system (e.g., work zone devices, portable devices, and/or carborne devices) that are not shown in FIG. 15 for simplicity of illustration.

In some embodiments, the processor(s) 902 may be configured to access the first known position 1002 and/or the second known position 1004 and determine the position of a device having no known position (e.g., a work zone device, a portable device, or a carborne device) using the known positions 1002 and/or 1004, such as in combination with relative position information obtained from the device. In some embodiments, the processor(s) 902 may be configured to store the position of the device in the non-volatile storage device 906 once determined using the known positions 1002 and/or 1004.

Having thus described several aspects and embodiments of the technology set forth in the disclosure, it is to be appreciated that various alterations, modifications, and improvements will readily occur to those skilled in the art. Such alterations, modifications, and improvements are intended to be within the spirit and scope of the technology described herein. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The above-described embodiments can be implemented in any of numerous ways. One or more aspects and embodiments of the present disclosure involving the performance of processes or methods may utilize program instructions executable by a device (e.g., a computer, a processor, or other device) to perform, or control performance of, the processes or methods. In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above. The computer readable medium or media can be transportable, such that the program or programs stored thereon can be loaded onto one or more different computers or other processors to implement various ones of the aspects described above. In some embodiments, computer readable media may be non-transitory media.

The terms “program” or “software” are used herein in a generic sense to refer to any type of computer code or set of computer-executable instructions that can be employed to program a computer or other processor to implement various aspects as described above. Additionally, it should be appreciated that according to one aspect, one or more computer programs that when executed perform methods of the present disclosure need not reside on a single computer or processor, but may be distributed in a modular fashion among a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code can be executed on any suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a Personal Digital Assistant (PDA), a smartphone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately” and “about” may be used to mean within ±20% of a target value in some embodiments, within ±10% of a target value in some embodiments, within ±5% of a target value in some embodiments, within ±2% of a target value in some embodiments. The terms “approximately” and “about” may include the target value.

What is claimed is:

1. A work zone device positioned along a train track, the work zone device configured to communicate with a first portable device associated with a first worker in a work zone along the train track, the work zone device comprising:
at least one first radio-frequency (RF) antenna configured to transmit RF signals to and receive RF signals from a carborne device on a train traveling along the train track; and
at least one first processor configured to:
determine a distance between the work zone device and the carborne device at least in part by transmitting at least one RF signal to and receiving at least one RF signal from the carborne device;
determine, based on the determined distance, whether to transmit an alert notification to the first portable device; and
transmit the alert notification to the first portable device when it is determined to transmit the alert notification to the first portable device.

2. The work zone device of claim 1, wherein the RF signals are ultra-wideband (UWB) signals.

3. The work zone device of claim 2, wherein the at least one first RF antenna is configured to transmit and receive RF signals having a bandwidth of at least 500 megahertz (MHz).

4. The work zone device of claim 3, wherein the at least one first RF antenna is configured to transmit and receive RF signals in a range within 3-10 GHz.

5. The work zone device of claim 1, wherein:
the at least one first RF antenna is configured to receive a first RF signal from the carborne device; and
the at least one first processor is configured to determine, based on receiving the first RF signal, that the distance between the work zone device and the carborne device is within a predetermined threshold distance.

6. The work zone device of claim 1, wherein:
the at least one first RF antenna is configured to transmit a first RF signal to the carborne device and receive a second RF signal from the carborne device; and
the at least one first processor is configured to determine the distance between the first device and the second device using a time of arrival of the second RF signal.

7. The work zone device of claim 1, wherein the alert notification is configured to cause the first portable device to alert the first worker in response to receiving the alert notification.

8. A system, comprising:
a work zone device positioned along a train track, the work zone device comprising:
at least one first radio-frequency (RF) antenna configured to transmit RF signals to and receive RF signals from a carborne device on a train traveling along the train track; and
at least one first processor configured to:
determine a distance between the work zone device and the carborne device at least in part by transmitting at least one RF signal to and receiving at least one RF signal from the carborne device;
determine, based on the determined distance, whether to transmit an alert notification; and
transmit the alert notification when it is determined to transmit the alert notification; and
a first portable device associated with a first worker in a work zone along the train track, the first portable device comprising:
at least one second RF antenna configured to receive the alert notification from the work zone device; and
at least one second processor configured alert the first worker in response to receiving the alert notification.

9. The system of claim 8, wherein:
the at least one first RF antenna is configured to receive a first RF signal from the carborne device; and
the at least one first processor is configured to determine, based on receiving the first RF signal, that the distance between the work zone device and the carborne device is within a predetermined threshold distance.

10. The system of claim 8, wherein:
the at least one first RF antenna is configured to transmit a first RF signal to the carborne device and receive a second RF signal from the carborne device; and
the at least one first processor is configured to determine the distance using a time of arrival of the second RF signal.

11. The system of claim 8, wherein the at least one first RF antenna is configured to transmit and receive ultra-wideband (UWB) signals having a bandwidth of at least 500 MHz.

12. The system of claim 8, wherein the at least one second processor of the first portable device is configured to generate an alert selected from the group consisting of an audio alert, a haptic alert, and a visual alert for the first worker responsive to receiving the alert notification from the work zone device.

13. The system of claim 12, wherein the at least one second processor of the first portable device is configured to:
receive an input from the first worker confirming that the alert was received; and
transmit a signal indicating that the alert has been confirmed to the work zone device.

14. A method performed by a work zone device positioned along a train track, the method comprising:
determining a distance between the work zone device and a carborne device, at least in part, by transmitting at least one radio-frequency (RF) signal to and/or receiving at least one RF signal from the carborne device;
determining, based on the determined distance, whether to transmit an alert notification to a first portable device, wherein the first portable device is associated with a first worker in a work zone along the train track; and
transmitting the alert notification to the first portable device when it is determined to transmit the alert notification to the first portable device.

15. The method of claim 14, wherein the RF signals are ultra-wideband (UWB) signals having a bandwidth of at least 500 megahertz (MHz).

16. The method of claim 15, wherein the RF signals are in a 3-10 GHz frequency range.

17. The method of claim 14, further comprising:
receiving a first RF signal from the carborne device; and
determining, based on receiving the first RF signal, that the distance between the work zone device and the carborne device is within a predetermined threshold distance.

18. The method of claim 14, further comprising:
transmitting a first RF signal to the carborne device;
receiving a second RF signal from the carborne device; and
determining the distance between the first device and the second device using a time of arrival of the second RF signal.

19. The method of claim 18, further comprising:
receiving the alert notification from the work zone device at the first portable device; and
generating an alert selected from the group consisting of an audio alert, a haptic alert, and a visual alert.

20. The method of claim 19, further comprising:
receiving an input from the first worker confirming that the alert was received; and
transmitting a signal indicating that the alert has been confirmed to the work zone device.
